(19) United States
(12) Patent Application Publication
(10) Pub. No.: US 2015/0200423 A1
(43) Pub. Date: Jul. 16, 2015

(54) SECONDARY BATTERY, BATTERY PACK, ELECTRIC VEHICLE, POWER STORAGE SYSTEM, POWER TOOL, AND ELECTRONIC DEVICE

(71) Applicant: Sony Corporation, Tokyo (JP)

(72) Inventors: Hiroki MITA, Kanagawa (JP); Toru ODANI, Kanagawa (JP); Tadahiko KUBOTA, Kanagawa (JP)

(21) Appl. No.: 14/592,621

(22) Filed: Jan. 8, 2015

(30) Foreign Application Priority Data
Jan. 15, 2014 (JP) 2014-004811

(51) Int. Cl. H01M 10/0567; B60L 11/18; H01M 4/525; H01M 10/42; H01M 10/0525; H01M 4/505

(52) U.S. Cl. CPC H01M 10/0567; H01M 10/0525; H01M 4/505; H01M 4/525; H01M 10/425; B60L 11/1851; H01M 2004/028

(57) ABSTRACT

A secondary battery including a cathode, an anode, and a non-aqueous electrolytic solution, in which the cathode includes an electrode compound which absorbs and releases an electrode reactant at a potential of 4.5 V or higher (potential versus lithium), and the non-aqueous electrolytic solution includes a silyl compound where one or two or more silicon-oxygen-containing groups (SiR₃—O—: the three R's are respectively any one of a monovalent hydrocarbon group and a halogenated group thereof) are bonded with an atom other than silicon.

### CROSS REFERENCES TO RELATED APPLICATIONS

The present application claims priority to Japanese Priority Patent Application JP 2014-004811 filed in the Japan Patent Office on Jan. 15, 2014, the entire content of which is hereby incorporated by reference.

### BACKGROUND

The present technology relates to a secondary battery which is provided with a cathode, an anode, and a non-aqueous electrolytic solution, and a battery pack, an electric vehicle, a power storage system, a power tool, and an electronic device which use the secondary battery.

In recent years, various types of electronic devices such as mobile phones and personal digital assistants (PDAs) have come into widespread use and there is a demand for further miniaturization, weight reduction, and longer lifespans for these electronic devices. Along with this, development of a battery as a power source, particularly a secondary battery which is small and light and able to obtain a high energy density, is under way.

Recently, the application of secondary batteries in various types of uses has been considered without being limited to the electronic devices described above. Examples of the uses include battery packs which are mounted so as to be able to be attached and detached to an electronic device or the like, electric vehicles such as an electric car, power storage systems such as a power server for home use, and power tools such as a power drill.

Secondary batteries which use various types of charging and discharging principles in order to obtain a battery capacity have been proposed; however, a secondary battery which uses the absorption and release of an electrode reactant is attracting attention among these. The reason is that it is possible to obtain a higher energy density than that of a lead battery, a nickel-cadmium battery, or the like.

A secondary battery is provided with a cathode, an anode, and a non-aqueous electrolytic solution. The cathode includes a cathode active substance which is involved in a charge and discharge reaction and the anode includes an anode active substance which is involved in a charge and discharge reaction. The non-aqueous electrolytic solution includes a non-aqueous solvent and an electrolyte salt. Since a configuration of the secondary battery has a great influence on the battery characteristics, careful consideration is given to the configuration of the secondary battery.

In detail, in order to improve the output characteristic and the like, lithium cobaltate (LiCoO₂) and the like are used as the cathode active substance and tris(trimethylsilyl) phosphite and the like are used as an additive for the non-aqueous electrolytic solution (for example, refer to Japanese Unexamined Patent Application Publications No. 2001-283908, No. 2007-123097, No. 2008-130544, and No. 2013-229341).

### SUMMARY

For electronic devices and the like, more and more improvements have been made in terms of high performance and multifunctionality. Along with this, since the frequency of use of electronic devices and the like is increasing, there is a tendency for secondary batteries to be frequently charged and discharged. Thus, there is still room for the improvement regarding the battery characteristics of secondary batteries.

It is desirable to provide a secondary battery which is able to obtain excellent battery characteristics, a battery pack, an electric vehicle, a power storage system, a power tool, and an electronic device.

A secondary battery of an embodiment of the present technology includes a cathode, an anode, and a non-aqueous electrolytic solution. The cathode includes an electrode compound which absorbs and releases an electrode reactant at a potential of 4.5 V or higher (potential versus lithium). The non-aqueous electrolytic solution includes a silyl compound where one or two or more silicon-oxygen-containing groups (SiR₃—O—: the three R's are respectively any one of a monovalent hydrocarbon group and a halogenated group thereof) are bonded with an atom other than silicon.

The battery pack, the electric vehicle, the power storage system, the power tool, or the electronic device of another embodiment of the present technology includes a secondary battery and the secondary battery has the same configuration as the secondary battery of the present technology described above.

Here, the type of the silyl compound is not particularly limited as long as the silyl compound is a compound which includes a structure where one or two or more silicon-oxygen-containing groups are bonded with an atom other than silicon. A “monovalent hydrocarbon group” is a general term for a monovalent group which is formed by carbon (C) and hydrogen (H). The monovalent hydrocarbon group may be in a straight-chain form or may be in a branched form which has one or two or more side chains. In addition, the monovalent hydrocarbon group may be a saturated hydrocarbon group which does not include a carbon-carbon multiple bond or may be an unsaturated hydrocarbon group which includes one or two or more carbon-carbon multiple bonds. The carbon-carbon multiple bond is one or both of a carbon-carbon double bond (>C═C<) and a carbon-carbon triple bond (—C≡C—). A “halogenated group” is a group where one or two or more hydrogen groups (—H) in the monovalent hydrocarbon group described above are substituted with a halogen group. The type of the halogen group is not particularly limited as long as the type is any one type or two types or more from among groups formed of halogen elements.

According to the secondary battery of the embodiments of the present technology, since the cathode includes the electrode compound described above and the non-aqueous electrolytic solution includes the silyl compound described above, it is possible to obtain excellent battery characteristics. In addition, it is also possible to obtain the same effects in the battery pack, the electric vehicle, the power storage system, the power tool, or the electronic device of the embodiment of the present technology.

Additional features and advantages are described herein, and will be apparent from the following Detailed Description and the figures.

### BRIEF DESCRIPTION OF THE FIGURES

FIG. 1 is a cross-sectional diagram illustrating a configuration of a secondary battery (a cylindrical type) of an embodiment of the present technology;

FIG. 2 is a cross-sectional diagram which enlarges and illustrates a part of a winding electrode body shown in FIG. 1;

FIG. 3 is a perspective diagram illustrating a configuration of another secondary battery (a laminate film type) of an embodiment of the present technology;

FIG. 4 is a cross-sectional diagram taken along the line IV-IV of the winding electrode body shown in FIG. 3;

FIG. 5 is a perspective diagram illustrating a configuration of an application example (a battery pack: a single battery) of a secondary battery;

FIG. 6 is a block diagram illustrating a configuration of the battery pack shown in FIG. 5;

FIG. 7 is a block diagram illustrating a configuration of an application example (a battery pack: an assembled battery) of a secondary battery;

FIG. 8 is a block diagram illustrating a configuration of an application example (an electric vehicle) of a secondary battery;

FIG. 9 is a block diagram illustrating a configuration of an application example (a power storage system) of a secondary battery; and

FIG. 10 is a block diagram illustrating a configuration of an application example (a power tool) of a secondary battery.

### DETAILED DESCRIPTION

Below, detailed description will be given of embodiments of the present technology with reference to the diagrams. Here, the order of the description is as described below.

1. Secondary Battery
1-1. Cylindrical Type
1-2. Laminate Film Type

2. Use of Secondary Battery
2-1. Battery Pack (Single Battery)
2-2. Battery Pack (Assembled Battery)
2-3. Electric Vehicle
2-4. Power Storage System
2-5. Power Tool

1. Secondary Battery

Firstly, description will be given of a secondary battery of an embodiment of the present technology.

1-1. Cylindrical Type

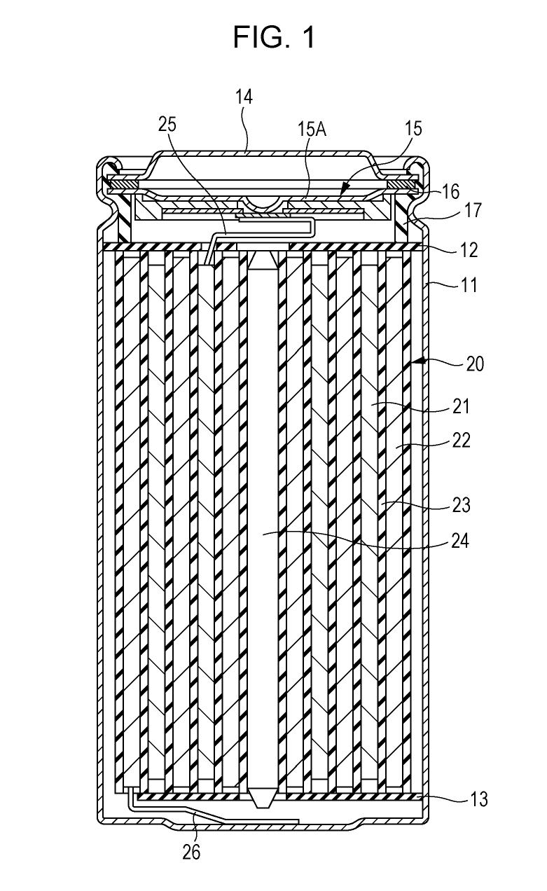

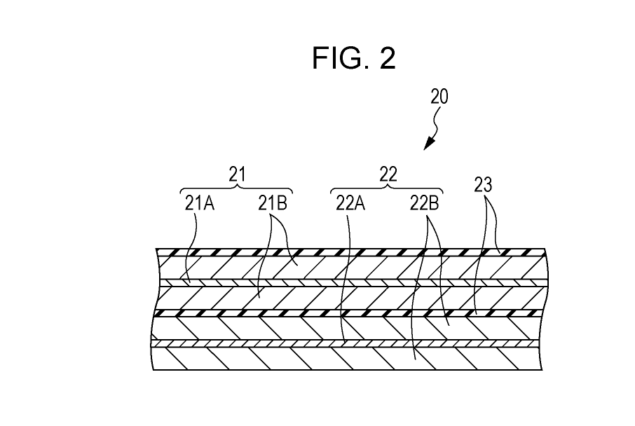

Each of FIG. 1 and FIG. 2 shows a cross-sectional configuration of a secondary battery of an embodiment of the present technology and a part of a winding electrode body 20 shown in FIG. 1 is enlarged in FIG. 2.

Overall Configuration of Secondary Battery

The secondary battery described here is, for example, a lithium ion secondary battery which is able to obtain a capacity in an anode 22 due to the absorption and release of lithium which is an electrode reactant.

The secondary battery is, for example, a so-called cylindrical type secondary battery and the winding electrode body 20 and a pair of insulation plates 12 and 13 are stored in an inner section of a battery can 11 with a substantially hollow columnar shape. The winding electrode body 20 is, for example, wound after a cathode 21 and the anode 22 are laminated via a separator 23.

The battery can 11 has a hollow structure where one end section is closed and the other end section is open and, for example, is formed of any one type or two types or more from among iron (Fe), aluminum (Al), alloys thereof, or the like. Nickel (Ni) or the like may be plated on the surface of the battery can 11. The winding electrode body 20 is interposed between the pair of the insulation plates 12 and 13 interpose and the pair is arranged to extend orthogonally with respect to the winding peripheral surface.

Since a battery lid 14, a safety valve mechanism 15, and a heat resistance element (a PTC element) 16 are caulked via a gasket 17 at an open end section of the battery can 11, the battery can 11 is sealed. The battery lid 14 is, for example, formed of the same material as the battery can 11. The safety valve mechanism 15 and the heat resistance element 16 are provided inside the battery lid 14 and the safety valve mechanism 15 is electrically connected with the battery lid 14 via the heat resistance element 16. In the safety valve mechanism 15, a disc plate 15A is reversed when the internal pressure reaches a certain level or more due to an internal short-circuit, heat from outside, or the like. Due to this, the electrical connection between the battery lid 14 and the winding electrode body 20 is cut. In order to prevent the abnormal generation of heat caused by a large current, the resistance of the heat resistance element 16 increases according to increases in the temperature. The gasket 17 is, for example, formed of an insulating material and asphalt or the like may be coated on the surface of the gasket 17.

For example, a center pin 24 is inserted in the center of the winding electrode body 20. However, it is not necessary for the center pin 24 to be inserted in the center of the winding electrode body 20. For example, a cathode lead 25 which is formed of a conductive material such as aluminum is connected with the cathode 21 and for example, an anode lead 26 which is formed of a conductive material such as nickel is connected with the anode 22. The cathode lead 25 is welded or the like to the safety valve mechanism 15 and is electrically connected with the battery lid 14. The anode lead 26 is welded or the like to the battery can 11 and is electrically connected with the battery can 11.

Cathode

The cathode 21 has a cathode active substance layer 21B on one surface or both surfaces of a cathode collector 21A. The cathode collector 21A is, for example, formed of a conductive material such as aluminum, nickel, or stainless steel.

The cathode active substance layer 21B includes a cathode active substance. However, the cathode active substance layer 21B may further include any one type or two types or more from among other materials such as a cathode binding agent and a cathode conductive agent.

The cathode active substance includes any one type or two types or more from among cathode materials which are able to absorb and release an electrode reactant. In detail, the cathode material includes any one type or two types or more from among electrode compounds (referred to below as “high potential materials”) which absorb and release an electrode reactant at a potential of 4.5 V or higher (potential versus lithium).

The cathode material includes a high potential material. The reason is that a high battery capacity is obtained since the amount of the electrode reactant which is released from the cathode material during charging increases. Here, the “electrode reactant” is a substance which is involved in the electrode reaction and is, for example, lithium in a lithium ion secondary battery whose capacity is obtained due to the absorption and release of lithium.

The type of the high potential material is not particularly limited as long as the material is able to absorb and release an electrode reactant at a potential of 4.5 V or higher (potential versus lithium). The high potential material is able to absorb and release the electrode reactant at a potential in this range. The reason is that a decrease in the battery capacity is suppressed even when charging and discharging are repeated since a decomposition reaction in the electrolytic solution which is caused by the reactivity of the cathode 21 (the cathode active substance) is suppressed.

The type of the high potential material is, for example, any one type or two types or more from among materials which are able to absorb and release lithium as an electrode reactant. In more detail, the high potential material is, for example, an oxide which includes lithium and one type or two types or more of other elements as constituent elements.

Among these, it is preferable that the high potential material be any one type or two types or more from among compounds (lithium-containing compounds) which are represented by formula (1) to formula (3) respectively. The reason is that it is possible to easily obtain (synthesize) the high potential material and a high energy density is obtained.

Li₁₊ₐ(Mn_{b}Co_{c}Ni_{1-b-c})₁₋ₐM1_{d}O₂₋ₑ (1)

(M1 is at least one type from among elements which belong to group 2 to group 15 of the long form of the periodic table (excluding manganese (Mn), cobalt (Co), and nickel (Ni)). a to e satisfy 0<a<0.25, 0.3≦b<0.7, 0≦c<1−b, 0≦d≦1, and 0≦e≦1.)

Li_{f}Ni_{1-g-h}Mn_{g}M2ₕO₂₋ᵢXⱼ (2)

(M2 is at least one type from among elements which belong to group 2 to group 15 of the long form of the periodic table (excluding nickel and manganese). X is at least one type from among elements which belong to group 16 and group 17 of the long form of the periodic table (excluding oxygen (O)). f to j satisfy 0≦f≦1.5, 0≦g≦1, 0≦h≦1, −0.1≦i≦0.2, and 0≦j≦0.2)

LiM3ₖMn₂₋ₖO₄ (3)

(M3 is at least one type from among elements which belong to group 2 to group 15 of the long form of the periodic table (excluding manganese). k satisfies 0<k≦1.)

The lithium-containing compound shown in formula (1) (referred to below as a “first lithium-containing compound”) is a lithium composition oxide which has a layered rock salt type crystal structure.

The first lithium-containing compound is so-called lithium-rich as is clear from the range of the values which a may take. The first lithium-containing compound includes manganese and nickel in addition to lithium as constituent elements as is clear from the range of the values which b and c may take. Here, the first lithium-containing compound may or may not include each of cobalt and another element (M1) as constituent elements.

The type of M1 is not particularly limited as long as the type is any one type or two types or more from among elements which belong to group 2 to group 15 of the long form of the periodic table. However, manganese, cobalt, and nickel are excluded from the candidates for M1.

Specific examples of M1 are any one type or two types or more from among nickel, cobalt, magnesium (Mg), aluminum, boron (B), titanium (Ti), vanadium (V), chromium (Cr), iron, copper (Cu), zinc (Zn), zirconium (Zr), molybdenum (Mo), tin (Sn), calcium (Ca), strontium (Sr), tungsten (W), silicon (Si), and barium (Ba).

Among these, it is preferable that M1 be any one type or two types or more from among nickel, cobalt, chromium, iron, and copper. The reason is that a higher energy density is obtained.

Specific examples of the first lithium-containing compound are Li_{1.2}(Mn_{0.5}Ni_{0.5})_{0.8}O₂, Li_{1.15}(Mn_{0.65}Ni_{0.22}Co_{0.13})_{0.85}O₂, Li_{1.13}(Mn_{0.6}Ni_{0.2}Co_{0.2})_{0.87}Al_{0.01}O₂, and the like. However, the specific examples of the first lithium-containing compound may be compounds other than the compounds described above.

The lithium-containing compound shown in formula (2) (referred to below as a “second lithium-containing compound”) is a lithium composition oxide which has a layered rock salt type crystal structure in the same manner as the first lithium-containing compound described above.

The second lithium-containing compound is lithium-rich as is clear from the range of the values which f may take. The second lithium-containing compound may or may not include each of nickel, manganese, and another element (M2) as constituent elements as is clear from the range of the values which g and h may each take. In addition, the second lithium-containing compound may or may not include another element (X) as a constituent element as is clear from the range of the values which j may take.

The type of M2 is not particularly limited as long as the type is any one type or two types or more from among elements which belong to group 2 to group 15 of the long form of the periodic table. However, nickel and manganese are excluded from the candidates for M2.

Specific examples of M2 are any one type or two types or more from among cobalt, magnesium, aluminum, boron, titanium, vanadium, chromium, iron, copper, zinc, zirconium, molybdenum, tin, calcium, strontium, tungsten, silicon, and barium.

Among these, it is preferable that M2 be any one type or two types or more from among cobalt, chromium, iron, and copper. The reason is that a higher energy density is obtained.

The type of X is not particularly limited as long as the type is any one type or two types or more from among elements which belong to group 16 and group 17 of the long form of the periodic table. However, oxygen is excluded from the candidates for X.

Specific examples of X are any one type or two types or more from among fluorine (F), chlorine (Cl), bromine (Br), and iodine (I).

Among these, it is preferable that X be any one type or two types or more from among halogen elements and it is more preferable that X be fluorine. The reason is that a higher energy density is obtained.

Here, f is not particularly limited as long as 0≦f≦1.5 is satisfied; however, in particular, it is preferable that 0<f≦1.5 be satisfied. The reason is that a higher energy density is obtained since the second lithium-containing compound is lithium-rich.

Alternatively, h is not particularly limited as long as 0≦h≦1 is satisfied; however, in particular, it is preferable that 0≦h<1 be satisfied. The reason is that a higher energy density is obtained since the second lithium-containing compound includes one or both of nickel and manganese as constituent elements.

Specific examples of the second lithium-containing compound are LiCoO₂, Li(Ni_{0.5}Co_{0.2}Mn_{0.3})O₂, Li(Ni_{0.33}Co_{0.33}Mn_{0.33})O₂, and the like. However, the specific examples of the second lithium-containing compound may be compounds other than the compounds described above.

The lithium-containing compound shown in formula (3) (referred to below as a “third lithium-containing compound”) is a lithium composition oxide which has a spinel type crystal structure.

The third lithium-containing compound includes another element (M3) in addition to manganese as a constituent element as is clear from the range of the values which k may take.

The type of M3 is not particularly limited as long as the type is any one type or two types or more from among elements which belong to group 2 to group 15 of the long form of the periodic table. However, manganese is excluded from the candidates for M3.

Specific examples of M3 are any one type or two types or more from among nickel, cobalt, magnesium, aluminum, boron, titanium, vanadium, chromium, iron, copper, zinc, zirconium, molybdenum, tin, calcium, strontium, tungsten, silicon, and barium.

Among these, it is preferable that M3 be any one type or two types or more from among nickel, cobalt, chromium, iron, and copper. The reason is that a higher energy density is obtained.

Specific examples of the third lithium-containing compound are Li(Mn_{1.5}Ni_{0.5})O₄, LiCoMnO₄, and the like. However, the specific examples of the third lithium-containing compound may be compounds other than the compounds described above.

The first lithium-containing compound, the second lithium-containing compound, and the third lithium-containing compound are collectively referred to below as a “specific lithium-containing compound”.

For confirmation, in the description, an embodiment where the cathode material includes a specific lithium-containing compound is not particularly limited.

In detail, it is sufficient if the cathode material includes any one type or two types or more from among the first lithium-containing compound, the second lithium-containing compound, and the third lithium-containing compound. That is, the cathode material may include only any one type from among the first lithium-containing compound, the second lithium-containing compound, and the third lithium-containing compound, may include two types in an arbitrary combination, or may include all three types.

In addition, the cathode material may include any one type or two types or more from among first lithium-containing compounds. That is, the cathode material may include only one type of compound from among a series of compounds which correspond to the first lithium-containing compound or may include two types or more in an arbitrary combination. This applies to each of the second lithium-containing compound and the third lithium-containing compound in the same manner.

Here, the cathode material may further include any one type or two types or more from among other materials as long as the cathode material includes the specific lithium-containing compound described above.

The other materials are, for example, other lithium-containing compounds such as a lithium transition metal composition oxide and a lithium transition metal phosphate compound. A lithium transition metal composition oxide is an oxide which includes lithium and one or two or more transition metal elements as constituent elements. However, compounds which correspond to the specific lithium-containing compound are excluded from the lithium transition metal composition oxide. A lithium transition metal phosphate compound is a phosphate compound which includes lithium and one or two or more transition metal elements as constituent elements. Among these, it is preferable that the transition metal element be any one type or two types or more from among nickel, cobalt, manganese, iron, and the like. The reason is that a higher voltage is obtained. The chemical formula is, for example, represented by LiₓM11O₂ or Li_{y}M12PO₄. M11 and M12 in the formula are one type or more of a transition metal element. The values of x and y are different according to the charge and discharge state, but are generally 0.05≦x≦1.10 and 0.05≦y≦1.10.

Specific examples of the lithium transition metal composition oxide are LiMn₂O₄ and the like which have a spinel type crystal structure in addition to LiNiO₂ and the like which have a layered rock salt type crystal structure. Specific examples of the lithium transition metal phosphate compound are LiFePO₄, LiFe₁₋ᵤMnᵤPO₄(u<1), and the like which have an olivine type crystal structure.

In addition, the other materials are, for example, any one type or two types or more from among oxides, disulfides, chalcogenides, and conductive polymers. The oxides are, for example, titanium oxide, vanadium oxide, manganese dioxide, and the like. The disulfides are, for example, titanium disulfide, molybdenum disulfide, and the like. The chalcogenides are, for example, niobium selenide and the like. The conductive polymers are, for example, sulfur, polyaniline, polythiophene, and the like.

The cathode binding agent includes, for example, any one type or two types or more from among synthetic rubber, polymer materials, and the like. The synthetic rubber is, for example, styrene-butadiene-based rubber, fluorine-based rubber, ethylene-propylene-diene, and the like. The polymer material is, for example, polyvinylidene fluoride, polyimide, and the like. The crystal structure of the polyvinylidene fluoride which is used as the polymer material is not particularly limited.

The cathode conductive agent includes, for example, any one type or two types or more from among carbon materials and the like. The carbon materials are, for example, graphite, carbon black, acetylene black, Ketjen black, and the like. Here, the cathode conductive agent may be a metal material, a conductive polymer, or the like as long as the material has conductivity.

Anode

The anode 22 has an anode active substance layer 22B on one surface or both surfaces of an anode collector 22A.

The anode collector 22A is, for example, formed of a conductive material such as copper, nickel, or stainless steel. It is preferable that the surface of the anode collector 22A be roughened. The reason is that adhesion of the anode active substance layer 22B with respect to the anode collector 22A improves due to a so-called anchor effect. In this case, the surface of the anode collector 22A may be roughened at least in the region which opposes the anode active substance layer 22B. The method for the roughening is, for example, a method for forming minute particles using an electrolytic treatment. The electrolytic treatment is a method where unevenness is provided on the surface of the anode collector 22A by forming minute particles on the surface of the anode collector 22A using an electrolytic method in an electrolytic bath. Copper foil which is manufactured using the electrolytic method is generally referred to as electrolytic copper foil.

The anode active substance layer 22B includes any one type or two types or more from among anode materials which are able to absorb and release an electrode reactant as an anode active substance. However, the anode active substance layer 22B may further include any one type or two types or more from among other materials such as an anode binding agent and an anode conductive agent. Here, details regarding the anode binding agent and the anode conductive agent are the same as the details regarding the cathode binding agent and the cathode conductive agent.

However, in order to prevent the electrode reactant from unintentionally precipitating onto the anode 22 during charging, it is preferable that the chargeable capacity of the anode material be larger than the discharge capacity of the cathode 21. That is, it is preferable that the electrochemical equivalent of the anode material which is able to absorb and release the electrode reactant be larger than the electrochemical equivalent of the cathode 21. Here, the electrode reactant precipitating onto the anode 22 is, for example, a lithium metal in a case where the electrode reactant is lithium.

The anode material is, for example, any one type or two types or more from among carbon materials. The reason is that it is possible to stably obtain a high energy density since there are very few changes in the crystal structure at the time of absorbing and releasing the electrode reactant. In addition, the reason is that the conductivity of the anode active substance layer 22B improves since the carbon material also functions as the anode conductive agent.

The carbon materials are, for example, graphitizing carbon, non-graphitizing carbon, graphite, and the like. However, it is preferable that the spacing of (002) surface in non-graphitizing carbon be 0.37 nm or longer and it is preferable that the spacing of (002) surface in graphite be 0.34 nm or shorter. In more detail, the carbon materials are, for example, pyrolytic carbons, cokes, vitreous carbon fiber, organic polymer compound fired bodies, activated carbon, carbon blacks, and the like. These cokes include pitch coke, needle coke, petroleum coke, and the like. The organic polymer compound fired bodies are formed by a polymer compound such as phenol resin or furan resin being fired (being carbonated) at an appropriate temperature. Other than these, the carbon material may be low crystallinity carbon on which a heat treatment is carried out at a temperature of approximately 1000° C. or lower or may be amorphous carbon. Here, the shape of the carbon material may be any of a fiber shape, a ball shape, a particle shape, or a scale shape.

In addition, the anode material is, for example, a material (a metal-based material) which includes any one type or two types or more from among metal elements and semi-metal elements as constituent elements. The reason is that a high energy density is obtained.

The metal-based material may be any of a single body, an alloy, or a compound, may be two types or more thereof, or may be a material which has a phase of one type or two types or more thereof in at least a part. However, materials which include one type or more of a metal element and one type or more of a semi-metal element are also included in the alloys, in addition to materials formed of two types or more metal elements. In addition, the alloys may include a non-metal element. The form of the metal-based material is, for example, a solid solution, an eutectic crystal (an eutectic mixture), an intermetallic compound, coexisting substances with two types or more thereof, and the like.

The metal elements and the semi-metal elements described above are, for example, any one type or two types or more from among metal elements and semi-metal elements which are able to form an alloy and the electrode reactant. In detail, for example, the metal elements and the semi-metal elements are magnesium, boron, aluminum, gallium, indium (In), silicon, germanium (Ge), tin, lead (Pb), bismuth (Bi), cadmium (Cd), silver (Ag), zinc, hafnium (Hf), zirconium, yttrium (Y), palladium (Pd), platinum (Pt), and the like.

Among these, one or both of silicon and tin are preferable. The reason is that a remarkably high energy density is obtained since the ability to absorb and release the electrode reactant is excellent.

The material which includes one or both of silicon and tin as constituent elements may be any of a single body, an alloy, or a compound of silicon, may be any of a single body, an alloy, or a compound of tin, may be two types or more thereof, or may be a material which has a phase of one type or two types or more thereof in at least a part. Here, a single body has the meaning of a single body merely in a general sense (which may include a very small amount of impurities) and does not necessarily have a meaning of 100% purity.

The alloy of silicon includes, for example, any one type or two types or more from among tin, nickel, copper, iron, cobalt, manganese, zinc, indium, silver, titanium, germanium, bismuth, antimony, chromium, and the like as constituent elements other than silicon. The compound of silicon includes, for example, any one type or two types or more from among carbon, oxygen, and the like as constituent elements other than silicon. Here, the compound of silicon may include, for example, any one type or two types or more from among the series of elements described regarding the alloy of silicon as constituent elements other than silicon.

Specific examples of the alloy of silicon and the compound of silicon are SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≦2), LiSiO, and the like. Here, v in SiOᵥ may be 0.2<v<1.4.

The alloy of tin includes, for example, any one type or two types or more from among silicon, nickel, copper, iron, cobalt, manganese, zinc, indium, silver, titanium, germanium, bismuth, antimony, chromium, and the like as constituent elements other than tin. The compound of tin includes, for example, any one type or two types or more from among carbon, oxygen, and the like as constituent elements other than tin. Here, the compound of tin may include, for example, any one type or two types or more from among the series of elements described regarding the alloy of tin as constituent elements other than tin.

Specific examples of the alloy of tin and the compound of tin are SnO_{w} (0<w≦2), SnSiO₃, LiSnO, Mg₂Sn, and the like.

In particular, it is preferable that a material which includes tin as a constituent element be, for example, a material (a Sn-containing material) which includes second and third constituent elements as constituent elements in addition to tin (a first constituent element). The second constituent element includes, for example, any one type or two types or more from among cobalt, iron, magnesium, titanium, vanadium, chromium, manganese, nickel, copper, zinc, gallium, zirconium, niobium, molybdenum, silver, indium, cesium (Ce), hafnium (Hf), tantalum, tungsten, bismuth, silicon, and the like. The third constituent element includes, for example, any one type or two types or more from among boron, carbon, aluminum, phosphorus (P), and the like. The reason is that a high battery capacity, excellent cycle characteristics, and the like are obtained when the Sn-containing material includes the second and third constituent elements.

Among these, it is preferable that the Sn-containing material be a material (a SnCoC-containing material) which includes tin, cobalt, and carbon as constituent elements. In the SnCoC-containing material, for example, the content of the carbon is 9.9 mass % to 29.7 mass % and the ratio of the content of tin and cobalt (Co/(Sn+Co)) is 20 mass % to 70 mass %. The reason is that a high energy density is obtained.

The SnCoC-containing material has a phase which includes tin, cobalt, and carbon and it is preferable that the phase be low crystallinity or amorphous. Since the phase is a reaction phase which is able to react with an electrode reactant, excellent characteristics are obtained due to the reaction phase. It is preferable that a half-value width of a diffraction peak (a diffraction angle 2θ) which is obtained by X-ray diffraction of the reaction phase be 1° or more in a case where a CuKα ray is used as a specific X-ray and an inserting and drawing speed is set to 1°/min. The reason is that the electrode reactant is more smoothly absorbed and released and the reactivity with an electrolytic solution decreases. Here, there are also cases where the SnCoC-containing material includes a phase where a single body or a part of each of the constituent elements is included in addition to the low crystallinity or amorphous phase.

It is possible to easily determine whether or not the diffraction peak which is obtained by the X-ray diffraction corresponds to the reaction phase which is able to react with the electrode reactant by comparing an X-ray diffraction chart before and after the electrochemical reaction with the electrode reactant. For example, when the position of the diffraction peak changes before and after the electrochemical reaction with the electrode reactant, the diffraction peak corresponds to the reaction phase which is able to react with an electrode reactant. In this case, for example, the diffraction peak of the low crystallinity or amorphous reaction phase, that is 2θ, is seen between 20° and 50°. Such a reaction phase includes, for example, each of the constituent elements described above and it is considered to be low crystallinity or amorphous mainly due to the presence of carbon.

In the SnCoC-containing material, it is preferable that at least a part out of the carbon which is a constituent element be bonded with a metal element or a semi-metal element which is another constituent element. The reason is that the aggregation or crystallization of tin and the like is suppressed. It is possible to confirm the bonding state of elements using, for example, X-ray photoelectron spectroscopy (XPS). In commercially available apparatuses, for example, an Al-Kα ray, an Mg-Kα ray, or the like may be used as a soft X-ray. In a case where at least a part out of the carbon is bonded with a metal element, a semi-metal element, or the like, the peak of a synthetic wave of a 1s trajectory (C1s) of carbon appears in a region which is lower than 284.5 eV. Here, energy calibration is carried out such that the peak of a 4f trajectory (Au4f) of a gold atom is obtained at 84.0 eV. At this time, generally, since surface contaminating carbon is present on the substance surface, the peak of C1s of the surface contaminating carbon is set to 284.8 eV and the peak is set as an energy reference. In the XPS measurement, the waveform of the peak of C1s is obtained in a form which includes the peak of the surface contaminating carbon and the peak of the carbon in the SnCoC-containing material. Due to this, for example, the peaks of both are separated by analysis using commercially available software. In the analysis of the waveform, the position of the main peak which is present on the minimum restraint energy side is set as an energy reference (284.8 eV).

The SnCoC-containing material is not limited to a material (SnCoC) where the constituent elements are only tin, cobalt, and carbon. The SnCoC-containing material may further include, for example, any one type or two types or more from among silicon, iron, nickel, chromium, indium, niobium, germanium, titanium, molybdenum, aluminum, phosphorus, gallium, bismuth, and the like in addition to tin, cobalt, and carbon as constituent elements.

Other than the SnCoC-containing material, a material (a SnCoFeC-containing material) which includes tin, cobalt, iron, and carbon as constituent elements is also preferable. The composition of the SnCoFeC-containing material is arbitrary. To give an example, in a case where the content of iron is set to be lower, the content of carbon is 9.9 mass % to 29.7 mass %, the content of iron is 0.3 mass % to 5.9 mass %, and the ratio of the content of tin and cobalt (Co/(Sn+Co)) is 30 mass % to 70 mass %. In addition, in a case where the content of iron is set to be greater, the content of carbon is 11.9 mass % to 29.7 mass %, the ratio of the content of tin, cobalt, and iron ((Co+Fe)/(Sn+Co+Fe)) is 26.4 mass % to 48.5 mass %, and the ratio of the content of cobalt and iron (Co/(Co+Fe)) is 9.9 mass % to 79.5 mass %. The reason is that a high energy density is obtained in such a composition range. Here, the physical properties (half-value width or the like) of the SnCoFeC-containing material are the same as the physical properties of the SnCoC-containing material described above.

Other than these, the anode material may be, for example, any one type or two types or more from among a metal oxide, a polymer compound, and the like. The metal oxide is, for example, an iron oxide, a ruthenium oxide, a molybdenum oxide, or the like. The polymer compound is, for example, polyacetylene, polyaniline, polypyrrole, or the like.

Among these, it is preferable that the anode material include both a carbon material and a metal-based material for the following reasons.

For the metal-based material, in particular, for a material which includes one or both of silicon and tin as a constituent element, there is an advantage that the theoretical capacity is high, but there is a concern that the material will easily strongly expand and contract at the time of the electrode reaction. On the other hand, for the carbon material, there is a concern that the theoretical capacity is low, but there is an advantage in that the material does not easily expand and contract at the time of the electrode reaction. Thus, by using both the carbon material and the metal-based material, expansion and contraction at the time of the electrode reaction are suppressed while obtaining a high theoretical capacity (in other words, the battery capacity).

The anode active substance layer 22B is formed by a method of any one type or two types or more from among, for example, a coating method, a gas phase method, a liquid phase method, a thermal spraying method, a firing method (a sintering method), or the like. The coating method is, for example, a method where an anode active substance in particle (powder) form is mixed with an anode binding agent or the like, the mixture is dispersed in a solvent such as an organic solvent, and then the anode collector 22A is coated with the resultant. The gas phase method is, for example, a physical deposition method, a chemical deposition method, or the like. In more detail, for example, the gas phase method is a vacuum vapor deposition method, a sputtering method, an ion plating method, a laser ablation method, a thermal chemical vapor deposition, a chemical vapor deposition (CVD) method, a plasma chemical vapor deposition method, or the like. The liquid phase method is, for example, an electrolytic plating method, a non-electrolytic plating method, or the like. The thermal spraying method is a method which sprays an anode active substance in a molten state or a half-molten state onto the anode collector 22A. The firing method is, for example, a method where a mixture which is dispersed in a solvent is coated onto the anode collector 22A using a coating method and then heat treatment is carried out on the resultant at a higher temperature than the melting point of an anode binding agent or the like. It is possible to use, for example, an atmosphere firing method, a reaction firing method, a hot pressing firing method, or the like as the firing method.

In the secondary battery, as described above, in order to prevent an electrode reactant from unintentionally precipitating onto the anode 22 during the charging, the electrochemical equivalent of the anode material which is able to absorb and release an electrode reactant is greater than the electrochemical equivalent of the cathode. In addition, when the open circuit voltage (that is, the battery voltage) at the time of being fully charged is 4.25 V or higher, since the release amount of the electrode reactant per unit mass is large even when using the same cathode active substance compared to the case of 4.20 V, the amounts of the cathode active substance and the anode active substance are adjusted in accordance with this fact. Due to this, a high energy density is obtained.

Separator

The separator 23 separates the cathode 21 and the anode 22 and allows lithium ions to pass therethrough while preventing a short-circuit of a current which is caused by the contact of both electrodes. The separator 23 is, for example, a porous film such as a synthetic resin or a ceramic and may be a laminated film where two types or more of porous films are laminated. The synthetic resin is, for example, polytetrafluoroethylene, polypropylene, polyethylene, or the like.

In particular, the separator 23 may include, for example, the porous film (a base material layer) described above and a polymer compound layer which is provided on one surface or both surfaces of the base material layer. The reason is that deformation of the winding electrode body 20 is suppressed since the adhesion of the separator 23 with respect to the cathode 21 and the anode 22 improves. Due to this, since the decomposition reaction of the electrolytic solution is suppressed and liquid leakage of the electrolytic solution which is impregnated in the base material layer is also suppressed, the resistance does not easily increase even when charging and discharging are repeated and battery swelling is suppressed.

The polymer compound layer includes, for example, a polymer material such as polyvinylidene fluoride. The reason is that polyvinylidene fluoride has excellent physical strength and is electrochemically stable. However, the polymer material may be a material other than polyvinylidene fluoride. In a case of forming the polymer compound layer, for example, a solution in which a polymer material is dissolved is coated on the base material layer and then the base material layer is dried. Here, the base material layer may be dried after immersing the base material layer in the solution.

Electrolytic Solution

A non-aqueous electrolytic solution (simply referred to below as an “electrolytic solution”) which is an electrolyte in liquid form is impregnated in the winding electrode body 20.

The electrolytic solution includes any one type or two types or more from among silyl compounds. The silyl compound is a compound where one or two or more silicon-oxygen-containing groups (SiR₃—O—: the three R's are respectively any one of a monovalent hydrocarbon group and a halogenated group thereof) are bonded with an atom (referred to below as a “non-silicon atom”) other than silicon.

The type of the silyl compound is not particularly limited as long as the compound includes a structure where one or two or more silicon-oxygen-containing groups are bonded with a non-silicon atom. The number of silicon-oxygen-containing groups is determined according to the type (the number of atomic bonds) of the non-silicon atom. The three R's may be the same type or may be different types. Naturally, only two of the three R's may be the same type.

The type of non-silicon atom is not particularly limited as long as the atom is an atom other than a silicon atom. Among these, it is preferable that the non-silicon atom be any atom from among aluminum, boron, phosphorus, sulfur, carbon, and hydrogen. The reason is that it is possible to easily synthesize the silyl compound.

“Monovalent hydrocarbon group” is a general term for a monovalent group which is formed of carbon and hydrogen. The monovalent hydrocarbon group may be in a straight-chain form or may be in a branched form which has one or two or more side chains. In addition, the monovalent hydrocarbon group may be a saturated hydrocarbon group which does not include a carbon-carbon multiple bond or may be an unsaturated hydrocarbon group which includes one or two or more carbon-carbon multiple bonds. The carbon-carbon multiple bond is one or both of a carbon-carbon double bond (>C═C<) and a carbon-carbon triple bond (—C≡C—).

In detail, the monovalent hydrocarbon group is, for example, any one of an alkyl group, an alkenyl group, an alkynyl group, a cycloalkyl group, an aryl group, and a group in which two types or more thereof are bonded so as to be monovalent.

The carbon number of the monovalent hydrocarbon group is not particularly limited. Among these, it is preferable that the carbon number of the alkyl group be 1 to 8 and it is preferable that the carbon number of each of the alkenyl group and the alkynyl group be 2 to 8. It is preferable that the carbon number of the cycloalkyl group be 3 to 18 and it is preferable that the carbon number of the aryl group be 6 to 18. The reason is that the solubility, mutual solubility, and the like of the silyl compound are secured.

Specific examples of the alkyl group are a methyl group (—CH₃), an ethyl group (—C₂H₅), a propyl group (—C₃H₇), an n-butyl group (—C₄H₈), a t-butyl group (—C(—CH₃)₂—CH₃), and the like. Specific examples of the alkenyl group are a vinyl group (—CH═CH₂), an allyl group (—CH₂—CH═CH₂), and the like. Specific examples of the alkynyl group are an ethynyl group (—C≡CH) and the like.

Specific examples of the cycloalkyl group are a cyclopropyl group, a cyclobutyl group, a cyclopentyl group, a cyclohexyl group, a cycloheptyl group, a cyclooctyl group, and the like. Specific examples of the aryl group are a phenyl group, a naphthyl group, and the like.

A “group in which two types or more are bonded so as to be monovalent” is a group in which two types or more from among the monovalent hydrocarbon groups described above are bonded so as to be monovalent as a whole (referred to below as a “monovalent bonding group”). The monovalent bonding group is, for example, a group where an alkyl group and an alkenyl group are bonded, a group where an alkyl group and an alkynyl group are bonded, a group where an alkenyl group and an alkynyl group are bonded, a group where an alkyl group and an aryl group are bonded, a group where an alkyl group and a cycloalkyl group are bonded, or the like.

A “halogenated group” is a group where one or two or more hydrogen groups (—H) in the monovalent hydrocarbon group described above are substituted with a halogen group. The type of the “halogen group” is not particularly limited; however, for example, the type is any one type or two types or more from among a fluorine group (—F), a chlorine group (—Cl), a bromine group (—Br), an iodine group (—I), and the like.

Here, R may be a group other than the groups described above. Other groups are, for example, a monovalent oxygen-containing hydrocarbon group, a halogenated group thereof, and the like. “Monovalent oxygen-containing hydrocarbon group” is a general term for a monovalent group which is formed of oxygen in addition to carbon and hydrogen. The monovalent oxygen-containing hydrocarbon group may be in a straight-chain form or may be in a branched form which has one or two or more side chains. In addition, the monovalent oxygen-containing hydrocarbon group may or may not include one or two or more carbon-carbon multiple bonds.

In detail, the monovalent oxygen-containing hydrocarbon group is, for example, an alkoxy group where the carbon number is 1 to 8. The reason is that the solubility, mutual solubility, and the like of the silyl compound are secured. Specific examples of the alkoxy group are a methoxy group (—OCH₃), an ethoxy group (—OC₂H₅), and the like.

A “halogenated group” is a group where one or two or more hydrogen groups in the monovalent oxygen-containing hydrocarbon groups described above are substituted with a halogen group. The types of the halogenated group are as described above.

In more detail, the silyl compound includes any one type or two types or more from among compounds which are represented by formula (4).

(SiR1₃-O—)ₘ—Y (4)

(The three R1's are respectively any one of a monovalent hydrocarbon group and a halogenated group thereof. Y is a group which includes any atom of aluminum, boron, phosphorus, sulfur, carbon, and hydrogen as a constituent atom. However, the ether bond (—O—) in the silicon-oxygen-containing groups is bonded with any atom from among aluminum, boron, phosphorus, sulfur, carbon, and hydrogen in Y. m is an integer of 1 or more.)

The details regarding R1 are the same as the details regarding R described above.

The type of Y is not particularly limited as long as the group includes any atom of aluminum, boron, phosphorus, sulfur, carbon, and hydrogen as a constituent atom (referred to below as an “essential atom”). That is, Y may include only an essential atom or may include any one type or two types or more from among other atoms in addition to the essential atom.

As described above, the value of m which determines the number of silicon-oxygen-containing groups (SiR1₃-O—) is determined according to the type of Y. To give an example, in a case where the number of atomic bonds of Y is 1, the number of silicon-oxygen-containing groups (the value of m) is 1. Alternatively, in a case where the number of atomic bonds of Y is 3, the number of silicon-oxygen-containing groups is 3.

However, in the bond between a silicon-oxygen-containing group and Y, it is necessary that the ether bond in the silicon-oxygen-containing group be bonded with an essential atom in Y. This is for preserving the function (the role) of the silyl compound described below.

Specific examples of Y are any group from among groups which are represented by formula (4-21) to formula (4-31) respectively. Here, the details regarding the “halogen group”, the “monovalent hydrocarbon group”, and the “halogenated group” are as described above.

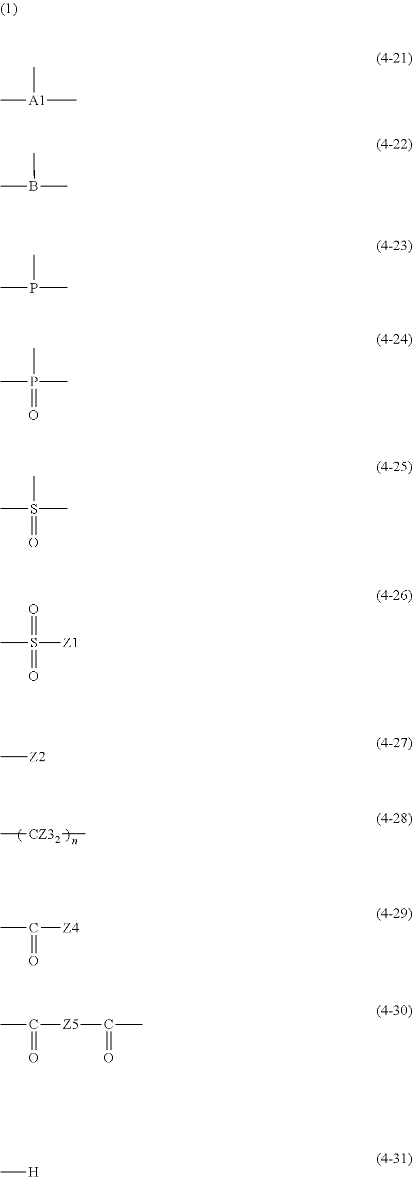

(Z1 is a halogen group. Z2 and Z4 are any one of a monovalent hydrocarbon group and a halogenated group thereof. Z3 is any one of a hydrogen group and a halogenated group. Z5 is any one of a divalent hydrocarbon group and a halogenated group thereof. n is an integer of 1 or more.)

The number of atomic bonds in Y is 1 in formula (4-26), formula (4-27), formula (4-29), and formula (4-31), 2 in formula (4-25), formula (4-28), and formula (4-30), and 3 in formula (4-21) to formula (4-24).

“Divalent hydrocarbon group” is a general term for a divalent group which is formed of carbon and hydrogen. The divalent hydrocarbon group may be in a straight-chain form or may be in a branched form which has one or two or more side chains. In addition, the divalent hydrocarbon group may be a saturated hydrocarbon group which does not include a carbon-carbon multiple bond or may be an unsaturated hydrocarbon group which includes one or two or more carbon-carbon multiple bonds.

In detail, the divalent hydrocarbon group is, for example, any one of groups where an alkylene group, an alkenylene group, an alkynylene group, a cycloalkylene group, an arylene group, and a group in which two types or more thereof are bonded so as to be divalent.

The carbon number of the divalent hydrocarbon group is not particularly limited. Among these, it is preferable that the carbon number of each of an alkylene group, an alkenylene group, and an alkynylene group be 2 to 8. In addition, it is preferable that the carbon number of a cycloalkylene group be 3 to 18 and it is preferable that the carbon number of an arylene group be 6 to 18. The reason is that the solubility, mutual solubility, and the like of the silyl compound are secured.

Specific examples of an alkylene group are a methylene group (—CH₂—), an ethylene group (—C₂H₄—), a propylene group (—C₃H₆—), a butylene group (—C₄H₈—), and the like. Specific examples of an alkenylene group are a vinylene group (—CH═CH—), an allylene group (— CH₂—CH═CH—), and the like. Specific examples of an alkynylene group are an ethynylene group (—C≡C—) and the like.

Specific examples of a cycloalkylene group are a cyclopropylene group, a cyclobutylene group, a cyclopentylene group, a cyclohexylene group, a cycloheptylene group, a cyclooctylene group, and the like. Specific examples of an arylene group are a phenylene group, a naphthylene group, and the like.

A “group in which two types or more are bonded so as to be divalent” is a group in which two types or more from among the divalent hydrocarbon groups described above are bonded so as to be divalent as a whole (referred to below as a “divalent bonding group”). The divalent bonding group is, for example, a group where an alkylene group and an alkenylene group are bonded, a group where an alkylene group and an alkynylene group are bonded, a group where an alkenylene group and an alkynylene group are bonded, a group where an alkylene group and an arylene group are bonded, a group where an alkylene group and a cycloalkylene group are bonded, and the like.

A “halogenated group” is a group where one or two or more hydrogen groups in the divalent hydrocarbon group described above are substituted with a halogen group. The types of the halogenated group are as described above.

The value of n is not particularly limited as long as the value is an integer of 1 or more; however, among these, an integer of 10 or less is preferable. The reason is that the solubility, mutual solubility, and the like of the silyl compound are secured.

Specific examples of the silyl compound are any one type or two types or more from among compounds which are represented by formula (4-1) to formula (4-17) respectively. However, the silyl compound may be a compound other than the compounds described below.

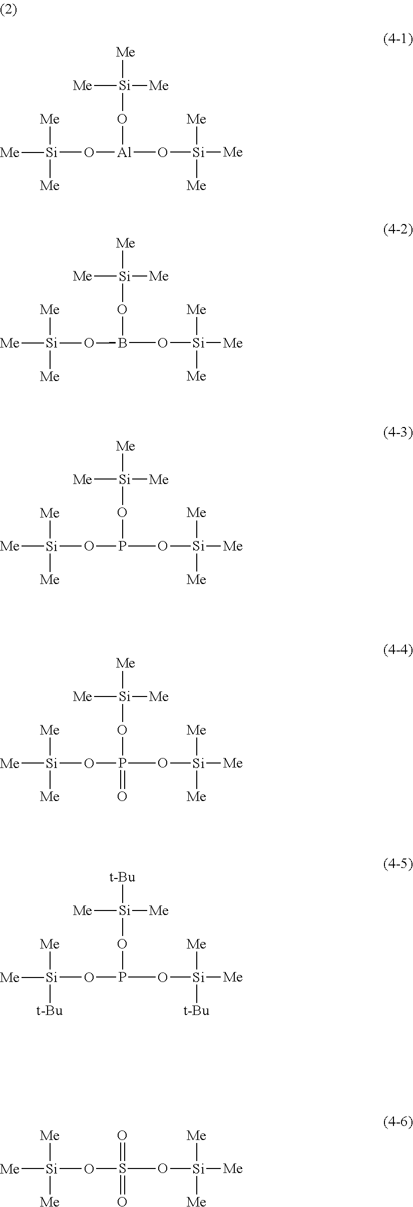

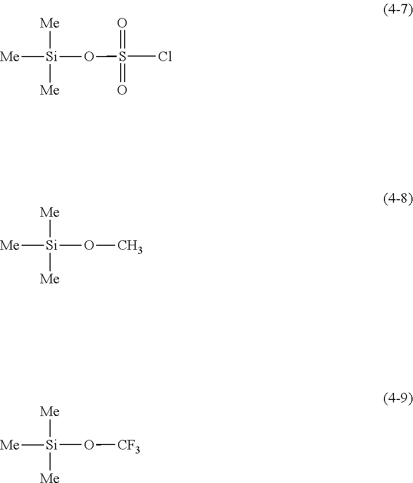

(-Me represents a methyl group, and -t-Bu represents a t-butyl group.)

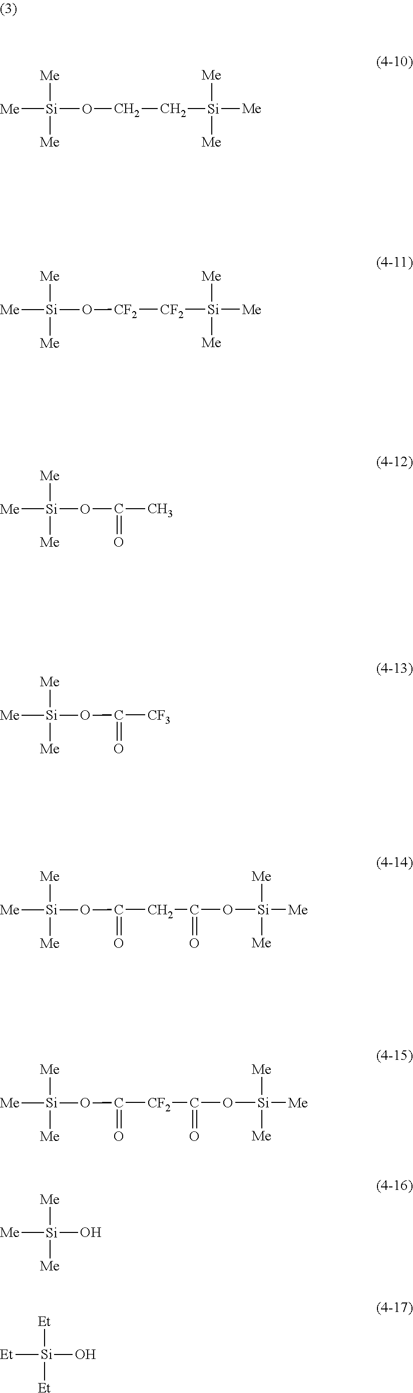

(-Me represents a methyl group and -Et represents an ethyl group.)

Here, the electrolytic solution includes a silyl compound. The reason is that the decomposition reaction of the electrolytic solution is suppressed even when the cathode 21 charges and discharges a secondary battery which includes a specific lithium-containing compound as the cathode active substance since the chemical stability of the electrolytic solution improves.

In detail, in a case of using a specific lithium-containing compound as the cathode active substance, for example, a high battery capacity is obtained by increasing a charging voltage (an upper limit voltage during charging) up to 4.5 V or higher. On the other hand, when the charging voltage is increased, since the reactivity of the specific lithium-containing compound is high, the decomposition reaction of the electrolytic solution is promoted when charging and discharging are repeated. Due to this, the battery capacity easily decreases and gas is easily generated. However, in a case where the electrolytic solution includes a silyl compound, when the charging voltage is increased up to 4.5 V or higher, a coating film which is derived from the silyl compound is specifically formed on the surface of the cathode 21. Due to this, since the chemical stability of the electrolytic solution specifically improves, the decomposition reaction of the electrolytic solution is remarkably suppressed even when repeatedly charging and discharging the secondary battery which uses the specific lithium compound. Thus, the battery capacity does not easily decrease and gas is also not easily generated. For confirmation, in the description, since the coating film described above is hardly formed in a case where the charging voltage is lower than 4.5 V, the decomposition suppressing function of the electrolytic solution due to the silyl compound is substantially not obtained.

Here, in a case of using a material other than the specific lithium-containing compound as the cathode active substance, since the charging voltage may not be inherently increased due to the physical properties of the other materials, the decomposition reaction of the electrolytic solution which is caused by a high charging voltage in the charging and discharging described above is intrinsically not easily generated.

Due to the above, the decomposition suppressing function of the electrolytic solution due to the silyl compound described above is specifically exhibited in a case of using the specific lithium-containing compound as the cathode active substance. On the other hand, the decomposition suppressing function of the electrolytic solution due to the silyl compound is substantially not exhibited in a case of using a material other than the specific lithium-containing compound as the cathode active substance.

The content of the silyl compound in the electrolytic solution is not particularly limited; however, a content of 0.01 wt % to 3 wt % is preferable. The reason is that the decomposition reaction of the electrolytic solution is further suppressed since the decomposition suppressing function of the electrolytic solution due to the silyl compound is sufficiently exhibited.

Here, the electrolytic solution may include any one type or two types or more from among a material other than the materials described below in addition to the silyl compound described above.

The other materials are, for example, any one type or two types or more from among solvents such as a non-aqueous solvent.

The non-aqueous solvent is for example, a cyclic carbonic ester, a chain carbonic ester, lactone, a chain carboxylate ester, nitrile, and the like. The reason is that an excellent battery capacity, cycle characteristics, storage characteristics, and the like are obtained. The cyclic carbonic ester is, for example, ethylene carbonate, propylene carbonate, butylene carbonate, and the like and the chain carbonic ester is, for example, dimethyl carbonate, diethyl carbonate, ethylmethyl carbonate, methylpropyl carbonate, and the like. The lactone is, for example, γ-butyrolactone, γ-valerolactone, and the like. The carboxylate ester is, for example, methyl acetate, ethyl acetate, methyl propionate, ethyl propionate, methyl butyrate, methyl isobutyrate, trimethyl methyl acetate, trimethyl ethyl acetate, and the like. The nitrile is, for example, acetonitrile, glutaronitrile, adiponitrile, methoxyacetonitrile, 3-methoxypropionitrile, and the like.

Other than these, the non-aqueous solvent may be, for example, 1,2-dimethoxyethane, tetrahydropyran, 2-methyltetrahydrofuran, tetrahydropyran, 1,3-dioxolane, 4-methyl-1,3-dioxolane, 1,3-dioxane, 1,4-dioxane, N,N-dimethylformamide, N-methylpyrrolidinone, N-methyloxazolidinone, N,N′-dimethyl imidazolidinone, nitromethane, nitroethane, sulfolane, phosphoric acid trimethyl, dimethyl sulfoxide, and the like. The reason is that the same advantage is obtained.

Among these, any one type or two types or more from among ethylene carbonate, propylene carbonate, dimethyl carbonate, diethyl carbonate, and ethylmethyl carbonate are preferable. The reason is that a superior battery capacity, cycle characteristics, storage characteristics, and the like are obtained. In this case, a combination of a high viscosity (a high dielectric constant) solvent such as ethylene carbonate or propylene carbonate (for example, a relative dielectric constant ∈≧30) and a low viscosity solvent such as dimethyl carbonate, ethylmethyl carbonate, and diethyl carbonate (for example, viscosity≦1 mPa·s) is more preferable. The reason is that the dissociation of the electrolyte salt and mobility of the ions improve.

In particular, the non-aqueous solvent may be any one type or two types or more from among unsaturated cyclic carbonic esters, halogenated carbonic esters, sultones (cyclic sulfonic esters), acid anhydrides, and the like. The reason is that the chemical stability of the electrolytic solution improves. The unsaturated cyclic carbonic esters are cyclic carbonic esters which have one or two or more unsaturated carbon bonds (one or both of a carbon-carbon double bond and a carbon-carbon triple bond) and include, for example, vinylene carbonate, vinylethylene carbonate, methylene ethylene carbonate, and the like. The halogenated carbonic esters are cyclic or chain carbonic esters which include one or two or more halogens as constituent elements. The cyclic halogenated carbonic esters are, for example, 4-fluoro-1,3-dioxolane-2-one, and 4,5-difluoro-1,3-dioxolane-2-one, and the like. The chain halogenated carbonic esters are, for example, fluoromethylmethyl carbonate, bis carbonate (fluoromethyl), difluoromethylmethyl carbonate, and the like. The sultones are, for example, propane sultone, propene sultone, and the like. The acid anhydrides are, for example, succinic anhydride, anhydrous ethane disulfonic acid, anhydrous sulfobenzoic acid, and the like. However, the non-aqueous solvent may be a compound other than the compounds described above.

The electrolyte salt includes, for example, any one type or two types or more from among salts such as lithium salt. However, the electrolyte salt may include a salt other than lithium salt. The salt other than lithium salt is, for example, a salt of a light metal other than lithium.

The lithium salt is, for example, lithium hexafluorophosphate (LiPF₆), lithium tetrafluoroborate (LiBF₄), lithium perchlorate (LiClO₄), lithium hexafluoroarsenate (LiAsF₆), lithium tetraphenyl borate (LiB(C₆H₅)₄), lithium methanesulfonate (LiCH₃SO₃), lithium trifluoromethanesulfonate (LiCF₃SO₃), lithium tetrachloroaluminate (LiAlCl₄), dilithium hexafluoride silicate (Li₂SiF₆), lithium chloride (LiCl), lithium bromide (LiBr), and the like. The reason is that an excellent battery capacity, cycle characteristics, storage characteristics, and the like are obtained.

Among these, any one type or two types or more from among LiPF₆, LiBF₄, LiClO₄, and LiAsF₆ are preferable, and LiPF₆ is more preferable. The reason is that a greater effect is obtained since the internal resistance decreases. However, the electrolyte salt may be a compound other than the compounds described above.

The content of the electrolyte salt is not particularly limited; however, a content of 0.3 mol/kg to 3.0 mol/kg with respect to the solvent is preferable. The reason is that a high ion conductivity is obtained.

Operation of Secondary Battery

The secondary battery is, for example, operated as follows.

During charging, when lithium ions are released from the cathode 21, the lithium ions are absorbed to the anode 22 via the electrolytic solution. On the other hand, during discharging, when lithium ions are released from the anode 22, the lithium ions are absorbed to the cathode 21 via the electrolytic solution.

Method for Manufacturing the Secondary Battery

The secondary battery is manufactured, for example, according to the following steps.

In a case of manufacturing the cathode 21, firstly, a cathode mixture is formed by mixing a cathode active substance which includes any one type or two types or more from among specific lithium-containing compounds and a cathode binding agent, a cathode conductive agent, and the like as necessary. Subsequently, a cathode mixture slurry in paste form is formed by dispersing the cathode mixture in an organic solvent or the like. Subsequently, a cathode active substance layer 21B is formed by coating both sides of the cathode collector 21A with a cathode mixture slurry and drying the cathode mixture slurry. Subsequently, the cathode active substance layer 21B is compressed and molded using a rolling press machine or the like while heating the cathode active substance layer 21B as necessary. In this case, the compression molding may be repeated a plurality of times.

In a case of manufacturing the anode 22, an anode active substance layer 22B is formed on the anode collector 22A according to the same steps as the cathode 21 described above. In detail, after forming an anode mixture by mixing an anode active substance, an anode binding agent, an anode conductive agent, and the like, an anode mixture slurry in a paste form is formed by dispersing the anode mixture in an organic solvent or the like. Subsequently, an anode active substance layer 22B is formed by drying the anode mixture slurry after coating both sides of the anode collector 22A with the anode mixture slurry. Finally, the anode active substance layer 22B is compressed and molded using a rolling press machine or the like.

In a case of preparing the electrolytic solution, after dispersing or dissolving the electrolyte salt in the solvent, any one type or two types or more from among silyl compounds are added to the solvent.

In a case of assembling a secondary battery using the cathode 21 and the anode 22, the cathode lead 25 is attached to the cathode collector 21A using a welding method or the like and the anode lead 26 is attached to the anode collector 22A using a welding method or the like. Subsequently, the winding electrode body 20 is manufactured by winding after laminating the cathode 21 and the anode 22 via the separator 23, and then the center pin 24 is inserted in the center of the winding electrode body 20. Subsequently, the winding electrode body 20 is stored inside the battery can 11 while interposing the winding electrode body 20 between a pair of the insulation plates 12 and 13. In this case, a tip end section of the cathode lead 25 is attached to the safety valve mechanism 15 using a welding method or the like and a tip end section of the anode lead 26 is attached to the battery can 11 using a welding method or the like. Subsequently, an electrolytic solution is injected inside the battery can 11 and the electrolytic solution is impregnated in the separator 23. Subsequently, the battery lid 14, the safety valve mechanism 15, and the heat resistance element 16 are caulked via the gasket 17 at an open end section of the battery can 11.

Operation and Effect of Secondary Battery

According to the cylindrical type secondary battery, the cathode 21 includes a specific lithium-containing compound and the electrolytic solution includes a silyl compound. In this case, as described above, the decomposition reaction of the electrolytic solution is specifically suppressed by the silyl compound even when a secondary battery, in which the cathode 21 includes a specific lithium-containing compound, charges and discharges under a high charging voltage condition. Thus, it is possible to obtain excellent battery characteristics since the discharging capacity does not easily decrease even when charging and discharging are repeated.

In particular, it is possible to obtain a greater effect when the high potential material includes any one type or two types or more from among the compounds which are represented by formula (1) to formula (3) respectively. In this case, it is possible to obtain an even greater effect when 0<f≦1.5 and 0≦h<1 are satisfied in formula (2).

In addition, it is possible to obtain an even greater effect when the silyl compound includes any one type or two types or more from among the compounds which are represented by formula (4), and in more detail, the compounds which are represented by each of formula (4-1) to (4-17). In this case, it is possible to obtain an even greater effect when the content of the silyl compounds in the electrolytic solution is 0.01 wt % to 3 wt %.

1-2. Laminate Film Type

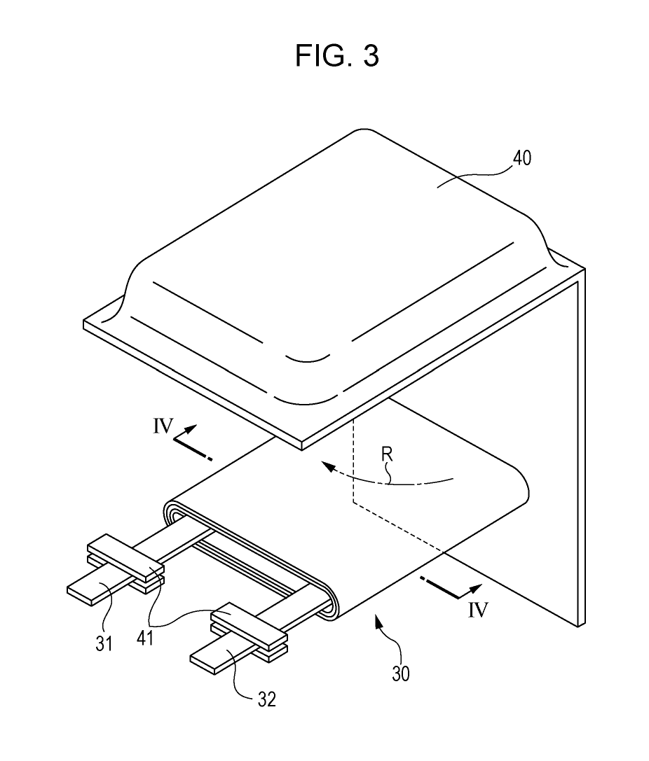

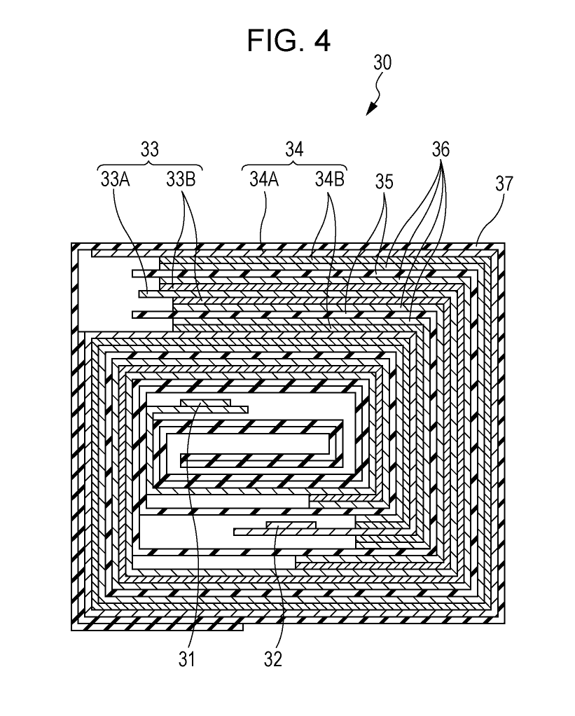

FIG. 3 illustrates a perspective view of a disassembled configuration of another secondary battery of an embodiment of the present technology and FIG. 4 is an enlarged view of a cross-section taken along the line IV-IV of a winding electrode body 30 shown in FIG. 3. Below, the constituent elements of the cylindrical type secondary battery described above will be referenced at times.

Overall Configuration of Secondary Battery

The secondary battery described here is, for example, a lithium ion secondary battery which has a so-called laminate film type battery structure.

In the secondary battery, for example, as shown in FIG. 3 and FIG. 4, the winding electrode body 30 is stored inside an external member 40 in a film form. The winding electrode body 30 is formed by being wound after a cathode 33 and an anode 34 are laminated via a separator 35 and an electrolytic layer 36. A cathode lead 31 is attached to the cathode 33 and an anode lead 32 is attached to the anode 34. The outermost peripheral section of the winding electrode body 30 is protected by a protective tape 37.

The cathode lead 31 and the anode lead 32 are, for example, led in the same direction from the inside of the external member 40 toward the outside. The cathode lead 31 is, for example, formed of any one type or two types or more from among conductive materials such as aluminum. The anode lead 32 is, for example, formed of any one type or two types or more from among conductive materials such as copper, nickel, and stainless steel. These conductive materials are, for example, in a thin plate form or in a mesh form.

The external member 40 is, for example, a sheet of film which is able to be folded in the direction of the arrow R shown in FIG. 3 and a hollow for storing the winding electrode body 30 is provided in a part of the external member 40. The external member 40 is, for example a laminate film where a fusion layer, a metal layer, and a surface protection layer are laminated in this order. In the manufacturing process of a secondary battery, after the external member 40 is folded such that fusion layers oppose each other via the winding electrode body 30, outer peripheral edge sections of the fusion layers are fused. However, the external member 40 may be formed by bonding two sheets of laminate films via an adhesive agent or the like. The fusion layer is, for example, a film of any one type or two types or more from among polyethylene, polypropylene, and the like. The metal layer is, for example, any one type or two types or more from among an aluminum foil and the like. The surface protection layer is, for example, a film of any one type or two types or more from among nylon, polyethylene terephthalate, and the like.

Among these, it is preferable that the external member 40 be an aluminum laminate film where a polyethylene film, an aluminum foil, and a nylon film are laminated in this order. However, the external member 40 may be a laminate film which has another laminate structure, may be a polymer film such as polypropylene, or may be a metal film.

An adhesive film 41 is inserted between the external member 40, and the cathode lead 31 and the anode lead 32 in order to prevent air from entering. The adhesive film 41 is formed of a material which has adhesion with respect to the cathode lead 31 and the anode lead 32. The material which has the adhesion is, for example, a polyolefin resin or the like, and in more detail, any one type or two types or more from among polyethylene, polypropylene, modified polyethylene, modified polypropylene, and the like.

The cathode 33 has, for example, a cathode active substance layer 33B on one surface or both surfaces of a cathode collector 33A and the anode 34 has, for example, an anode active substance layer 34B on one surface or both surfaces of an anode collector 34A. Each of the configurations of the cathode collector 33A, the cathode active substance layer 33B, the anode collector 34A, and the anode active substance layer 34B is, for example, the same as each of the configurations of the cathode collector 21A, the cathode active substance layer 21B, the anode collector 22A, and the anode active substance layer 22B. The configuration of the separator 35 is, for example, the same as the configuration of the separator 23.

The electrolytic layer 36 includes an electrolytic solution and a polymer compound and the electrolytic solution is held by the polymer compound. The electrolytic layer 36 is an electrolyte in a so-called gel form. The reason is that a high ion conductivity (for example, 1 mS/cm or more at room temperature) is obtained and liquid leakage of the electrolytic solution is prevented. The electrolytic layer 36 may further include another material such as an additive agent.

The polymer compound includes, for example, any one type or two types or more from among polyacrylonitrile, polyvinylidene fluoride, polytetrafluoroethylene, polyhexafluoropropylene, polyethylene oxide, polypropylene oxide, polyphosphazene, polysiloxane, polyvinyl fluoride, polyvinyl acetate, polyvinyl alcohol, polymethyl methacrylate, polyacrylic acid, polymethacrylic acid, styrene-butadiene rubber, nitrile-butadiene rubber, polystyrene, polycarbonate, and the like. Other than these, the polymer compound may be a copolymer. The copolymer is, for example, a copolymer of vinylidene fluoride and hexafluoropyrene and the like. Among these, polyvinylidene fluoride is preferable as a homopolymer and a copolymer of vinylidene fluoride and hexafluoropyrene is preferable as a copolymer. The reason is that the above compounds are electrochemically stable.

The composition of the electrolytic solution is, for example, the same as the composition of the electrolytic solution in the cylindrical type secondary battery. However, in the electrolytic layer 36 which is an electrolyte in a gel form, the solvent of the electrolytic solution is a broad concept which includes not only a material in a liquid form, but also a material which has ion conductivity which is able to separate the electrolyte salt. Thus, in a case of using a polymer compound which has ion conductivity, the polymer compound is also included in the solvent.

Here, instead of the electrolytic layer 36 in a gel form, the electrolytic solution may be used as it is. In this case, the electrolytic solution is impregnated in the winding electrode body 30.

Operation of Secondary Battery

The secondary battery is, for example, operated as follows.

During charging, when lithium ions are released from the cathode 33, the lithium ions are absorbed to the anode 34 via the electrolytic layer 36. On the other hand, during discharging, when lithium ions are released from the anode 34, the lithium ions are absorbed to the cathode 33 via the electrolytic layer 36.

Method for Manufacturing the Secondary Battery

The secondary battery which is provided with the electrolytic layer 36 in a gel form is, for example, manufactured according to the following three types of steps.

In the first step, the cathode 33 and the anode 34 are manufactured according to the same manufacturing steps as the cathode 21 and the anode 22. That is, in a case of manufacturing the cathode 33, the cathode active substance layer 33B is formed on both surfaces of the cathode collector 33A and in a case of manufacturing the anode 34, the anode active substance layer 34B is formed on both surfaces of the anode collector 34A. Subsequently, a precursor solution is prepared by mixing an electrolytic solution, a polymer compound, a solvent, and the like. The solvent is, for example, an organic solvent or the like. Subsequently, the electrolytic layer 36 in a gel form is formed by drying the precursor solution after coating each of the cathode 33 and the anode 34 with the precursor solution. Subsequently, the cathode lead 31 is attached to the cathode collector 33A using a welding method or the like and the anode lead 32 is attached to the anode collector 34A using a welding method or the like. Subsequently, the winding electrode body 30 is manufactured by winding after laminating the cathode 33 and the anode 34 via the separator 35, and then the protective tape 37 is attached to the outermost peripheral section thereof. Subsequently, after folding the external member 40 so as to interpose the winding electrode body 30, the winding electrode body 30 is enclosed inside the external member 40 by adhering outer peripheral edge sections of the external member 40 to each other using a heat fusion method or the like. In this case, the adhesive film 41 is inserted between the cathode lead 31 and the anode lead 32 and the external member 40.

In the second step, the cathode lead 31 is attached to the cathode 33 and the anode lead 32 is attached to the anode 34. Subsequently, after a winding body which is a precursor body of the winding electrode body 30 is manufactured by winding after laminating the cathode 33 and the anode 34 via the separator 35, and then the protective tape 37 is attached to the outermost peripheral section thereof. Subsequently, after folding the external member 40 so as to interpose the winding electrode body 30, the winding body is stored inside the external member 40 in a bag form by adhering the remaining outer peripheral edge sections except for an outer peripheral edge section of one side of the external member 40 using a heat fusion method or the like. Subsequently, a composition for an electrolyte is prepared by mixing an electrolytic solution, a monomer which is a raw material of a polymer compound, a polymerization initiator, and another material such as a polymerization inhibitor as necessary. Subsequently, the external member 40 is sealed using a heat fusion method or the like after injecting the composition for an electrolyte inside the external member 40 in a bag form. Subsequently, a polymer compound is formed by thermally polymerizing a monomer. Due to this, the electrolytic layer 36 in a gel form is formed.

In the third step, a winding body is manufactured and is stored inside the external member 40 in a bag form in the same manner as the second step described above except for using the separator 35 on which a polymer compound is coated on both surfaces. The polymer compound which is coated on the separator 35 is, for example, a polymer (a homopolymer, a copolymer, or a multi-component copolymer), which has vinylidene fluoride as a component, or the like. In detail, the polymer compound is a binary copolymer which has polyvinylidene fluoride, vinylidene fluoride, and hexafluoropropylene as components, a ternary copolymer which has vinylidene fluoride, and hexafluoropropylene, and chlorotrifluoroethylene as components, or the like. Here, another one type or two types or more of polymer compounds may be used together with the polymer which has vinylidene fluoride as a component. Subsequently, an opening section of the external member 40 is sealed using a heat fusion method or the like after preparing the electrolytic solution and injecting the solution inside the external member 40. Subsequently, the external member 40 is heated while adding pressure thereto and the separator 35 is adhered to the cathode 33 and the anode 34 via a polymer compound. Due to this, the electrolytic layer 36 is formed since the electrolytic solution is impregnated in the polymer compound and the polymer compound becomes a gel.

In the third step, swelling of the secondary battery is further suppressed than in the first step. In addition, in the third step, compared to the second step, since the monomer and the like which are the raw materials of the solvent and the polymer compound are hardly present in the electrolytic layer 36, the forming process of the polymer compound is favorably controlled. Due to this, the cathode 33, the anode 34, and the separator 35 and the electrolytic layer 36 are sufficiently adhered.

Operation and Effect of Secondary Battery

According to the laminate film type secondary battery, since the cathode 33 includes a specific lithium-containing compound and the electrolytic layer 36 (an electrolytic solution) includes a silyl compound, it is possible to obtain excellent battery characteristics for the same reason as the cylindrical type secondary battery. The operation and effects other than this are the same as those of the cylindrical type secondary battery.

2. Use of Secondary Battery

Next, description will be given of application examples of the secondary battery described above.

Uses of the secondary battery are not particularly limited as long as the use is for a machine, a device, a tool, an apparatus, a system (an aggregation of a plurality of devices), or the like where it is possible to use the secondary battery as a power source for driving, a power storage source for power accumulation, or the like. A secondary battery which is used as a power source may be a main power source (a power source which is preferentially used) or may be an auxiliary power source (a power source which is used instead of a main power source or by being switched from a main power source). In a case of using the secondary battery as an auxiliary power source, the type of the main power source is not limited to a secondary battery.

Uses of the secondary battery are, for example, as described below. These are electronic devices (which include portable electronic devices) such as a video camera, a digital still camera, a portable phone, a notebook personal computer, a cordless telephone, a headphone stereo, a portable radio, a portable television, and a portable information terminal. Other uses are a portable appliance such as an electric shaver; storage apparatuses such as a backup power source and a memory card; power tools such as a power drill and a power saw; a battery pack which is used for a notebook personal computer as a power source which is able to be attached and detached; electronic devices for medical use such as a pacemaker and a hearing aid; electric vehicles such as an electric car (which includes a hybrid car); and a power storage system such as a battery system for home use where power is accumulated for emergencies. Naturally, there may be other uses than the above.

Among these, applying the secondary battery to a battery pack, an electric vehicle, a power storage system, a power tool, an electronic device, or the like is effective. The reason is that it is possible to effectively improve the performance by using the secondary battery of the present technology since excellent battery characteristics are demanded. Here, a battery pack is a power source which uses the secondary battery and is a so-called assembled battery or the like. An electric vehicle is a vehicle which operates (runs) with the secondary battery as a power source for driving and may be a car (a hybrid car or the like) which is also provided with a driving source other than the secondary battery as described above. A power storage system is a system which uses the secondary battery as a power storage source. For example, since power is accumulated in the secondary battery which is a power storage source in a power storage system for home use, it is possible to use electric appliances for home use or the like by using power therefrom. A power tool is a tool where a movable section (for example, a drill or the like) is moved with the secondary battery as a power source for driving. An electronic device is a device which exhibits various types of functions with the secondary battery as a power source for driving (a power supply source).

Here, description will be given of some application examples of the secondary battery in detail. Here, the configuration of each of the application examples described below is merely an example and it is possible to change the configurations as appropriate.

2-1. Battery Pack (Single Battery)

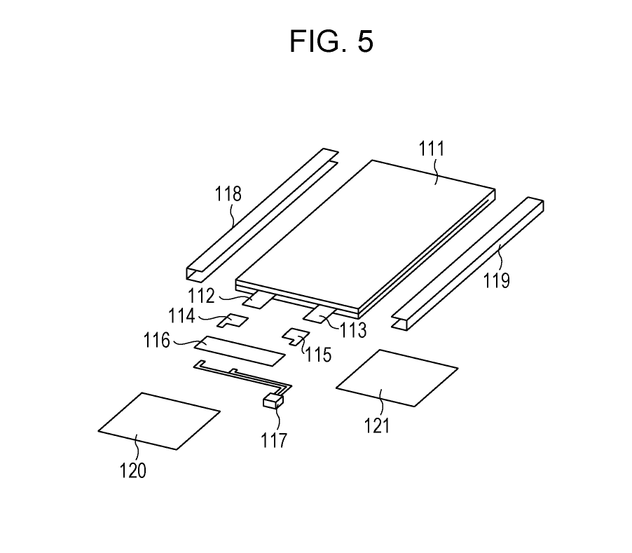

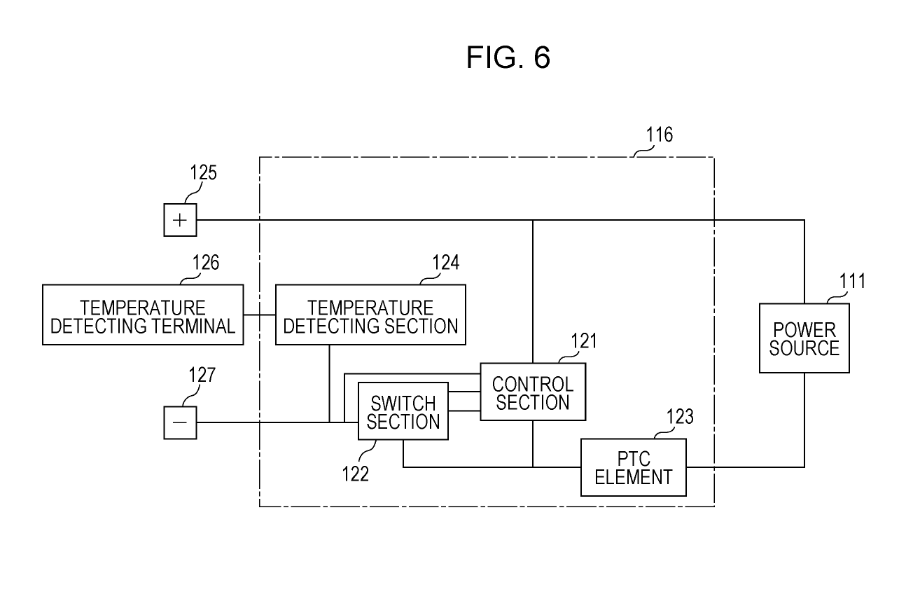

FIG. 5 represents a perspective configuration of a battery pack which uses a single battery and FIG. 6 represents a block configuration of the battery pack shown in FIG. 5. Here, FIG. 5 shows a state where the battery pack is disassembled.

The battery pack described here is a simple battery pack which uses one secondary battery (a so-called soft pack) and is, for example, mounted on an electronic device or the like represented by a smart phone. The battery pack is, for example, provided with a power source 111 which is a laminate film type secondary battery and a circuit board 116 which is connected with the power source 111 as shown in FIG. 5. A cathode lead 112 and an anode lead 113 are attached to the power source 111.

A pair of adhesive tapes 118 and 119 are attached to both side surfaces of the power source 111. A protection circuit (PCM: Protection Circuit Module) is formed in the circuit board 116. The circuit board 116 is connected with the cathode lead 112 via a tab 114 and is connected with the anode lead 113 via a tab 115. In addition, the circuit board 116 is connected with a lead line 117 which has a connector for external connection. Here, in a state where the circuit board 116 is connected with the power source 111, the circuit board 116 is protected on top and bottom by a label 120 and an insulation sheet 121. The circuit board 116, the insulation sheet 121, and the like are fixed by the attaching of the label 120.

In addition, the battery pack is, for example, provided with the power source 111 and the circuit board 116 as shown in FIG. 6. The circuit board 116 is, for example, provided with a control section 121, a switching section 122, a PTC 123, and a temperature detecting section 124. Since the power source 111 is able to be connected with the outside via a cathode terminal 125 and an anode terminal 127, the power source 111 is charged and discharged via the cathode terminal 125 and the anode terminal 127. The temperature detecting section 124 is able to detect the temperature using a temperature detecting terminal (a so-called T terminal) 126.

The control section 121 controls the operation of the entire battery pack (which includes the usage state of the power source 111) and includes, for example, a central processing unit (CPU), a memory, and the like.

For example, when the battery voltage reaches an overcharge detection voltage, the control section 121 prevents the charging current from flowing into the current path of the power source 111 by disconnecting the switching section 122. In addition, for example, when a large current flows during charging, the control section 121 interrupts the charging current by disconnecting the switching section 122.

Other than these, for example, when the battery voltage reaches an overdischarge detection voltage, the control section 121 prevents the discharging current from flowing into the current path of the power source 111 by disconnecting the switching section 122. In addition, for example, when a large current flows during discharging, the control section 121 interrupts the discharging current by disconnecting the switching section 122.

Here, the overcharge detection voltage of the secondary battery is, for example, 4.20 V±0.05 V and the overdischarge detection voltage is, for example, 2.4 V±0.1 V.

The switching section 122 switches the usage state of the power source 111 (whether or not it is possible to connect the power source 111 and an external device) according to the instructions of the control section 121. The switching section 122 includes, for example, a charging control switch, a discharging control switch, and the like. Each of the charging control switch and the discharging control switch is, for example, a semiconductor switch such as a metal oxide semiconductor field effect transistor (MOSFET). Here, the charging and discharging current is, for example, detected based on the ON resistance of the switching section 122.

The temperature detecting section 124 measures the temperature of the power source 111 and outputs the measurement result to the control section 121, and includes, for example, a temperature detecting element such as a thermistor. Here, the measurement result of the temperature detecting section 124 is used in a case where the control section 121 performs charging and discharging control at a time of abnormal heating, in a case where the control section 121 performs a correction process at the time of calculating the remaining capacity, or the like.

Here, it is not necessary for the circuit board 116 to be provided with the PTC 123. In this case, a PTC element may be separately equipped in the circuit board 116.

2-2. Battery Pack (Assembled Battery)

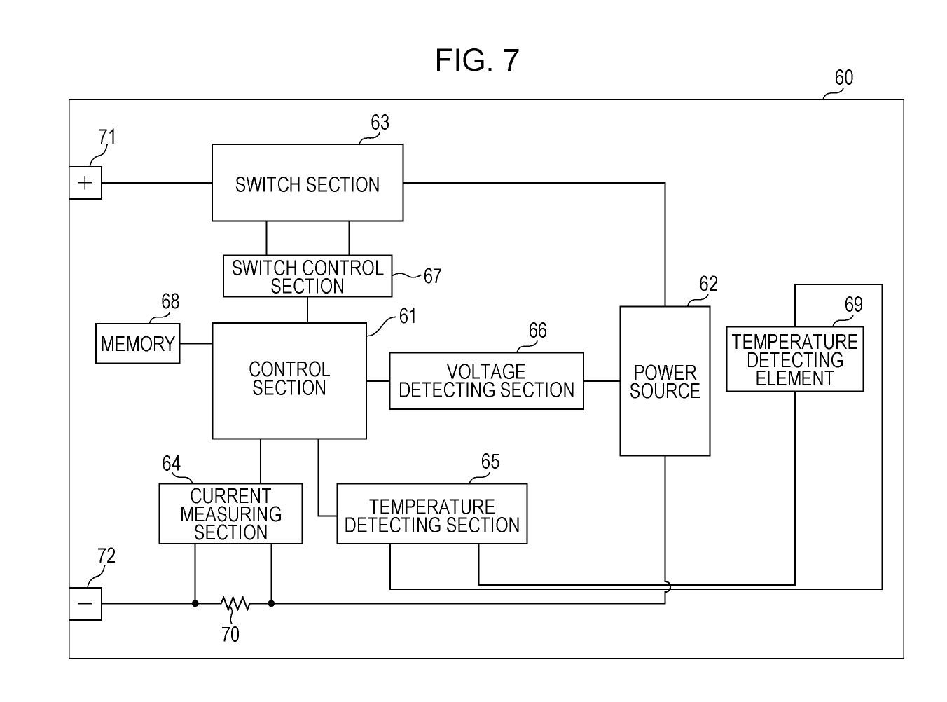

FIG. 7 represents a block configuration of a battery pack which uses an assembled battery. The battery pack is, for example provided with a control section 61, a power source 62, a switching section 63, a current measuring section 64, a temperature detecting section 65, a voltage detecting section 66, a switch control section 67, a memory 68, a temperature detecting element 69, a current detecting resistor 70, a cathode terminal 71, and an anode terminal 72 inside a housing 60 which is formed of a plastic material or the like.

The control section 61 controls the operation of the entire battery pack (which includes the usage state of the power source 62), and includes, for example, a CPU and the like. The power source 62 includes one or two or more secondary batteries (which are not shown in the diagram). The power source 62 is, for example, an assembled battery which includes two or more secondary batteries and the form of the connection of these secondary batteries may be in series, may be in parallel, or may be a mixed form of both. To give an example, the power source 62 includes six secondary batteries in which three sets of two batteries connected in parallel are connected in series.

The switching section 63 switches the usage state of the power source 62 (whether or not it is possible to connect the power source 62 and an external device) according to the instructions of the control section 61. The switching section 63 includes, for example, a charging control switch, a discharging control switch, a diode for charging, a diode for discharging, and the like (none of which are shown in the diagram). The charging control switch and the discharging control switch are, for example, a semiconductor switch such as a metal oxide semiconductor field effect transistor (MOSFET).

The current measuring section 64 measures the current using the current detecting resistor 70 and outputs the measurement result to the control section 61. The temperature detecting section 65 measures the temperature using the temperature detecting element 69 and outputs the measurement result to the control section 61. The temperature measurement result is, for example, used in a case where the control section 61 performs charging and discharging control at a time of abnormal heating, in a case where the control section 61 performs a correction process at the time of calculating the remaining capacity, or the like. The voltage detecting section 66 measures the voltage of the secondary battery in the power source 62 and supplies the measured voltage to the control section 61 by carrying out analog-digital conversion.

The switch control section 67 controls the operation of the switching section 63 according to signals which are input from the current measuring section 64 and the voltage detecting section 66.

For example, in a case where the battery voltage reaches the overcharge detection voltage, the switch control section 67 carries out control to prevent the charging current from flowing into the current path of the power source 62 by disconnecting the switching section 63 (a charging control switch). Due to this, in the power source 62, only discharging is possible via a diode for discharging. Here, for example, in a case where a large current flows during charging, the switch control section 67 interrupts the charging current.

In addition, for example, in a case where the battery voltage reaches an overdischarge detection voltage, the switch control section 67 prevents the discharging current from flowing into the current path of the power source 62 by disconnecting the switching section 63 (a discharging control switch). Due to this, in the power source 62, only charging is possible via a diode for charging. Here, for example, in a case where a large current flows during discharging, the switch control section 67 interrupts the discharging current.

Here, in the secondary battery, for example, the overcharge detection voltage is 4.20 V±0.05 V and the overdischarge detection voltage is 2.4 V±0.1 V.

The memory 68 is, for example, an EEPROM or the like which is a nonvolatile memory. For example, numeric values which are calculated by the control section 61, information on the secondary battery which is measured in the manufacturing step stage (for example, internal resistance in the initial state, and the like), and the like are stored in the memory 68. Here, if the fully charged capacity of the secondary battery is stored in the memory 68, the control section 61 is able to ascertain information such as the remaining capacity.

The temperature detecting element 69 measures the temperature of the power source 62 and outputs the measurement result to the control section 61, and is, for example, a thermistor or the like.

The cathode terminal 71 and the anode terminal 72 are terminals which are connected with an external device which is operated using a battery pack (for example, a notebook personal computer or the like), an external device which is used for charging a battery pack (for example, a charger or the like), or the like. Charging and discharging of the power source 62 is performed via the cathode terminal 71 and the anode terminal 72.

2-3. Electric Vehicle

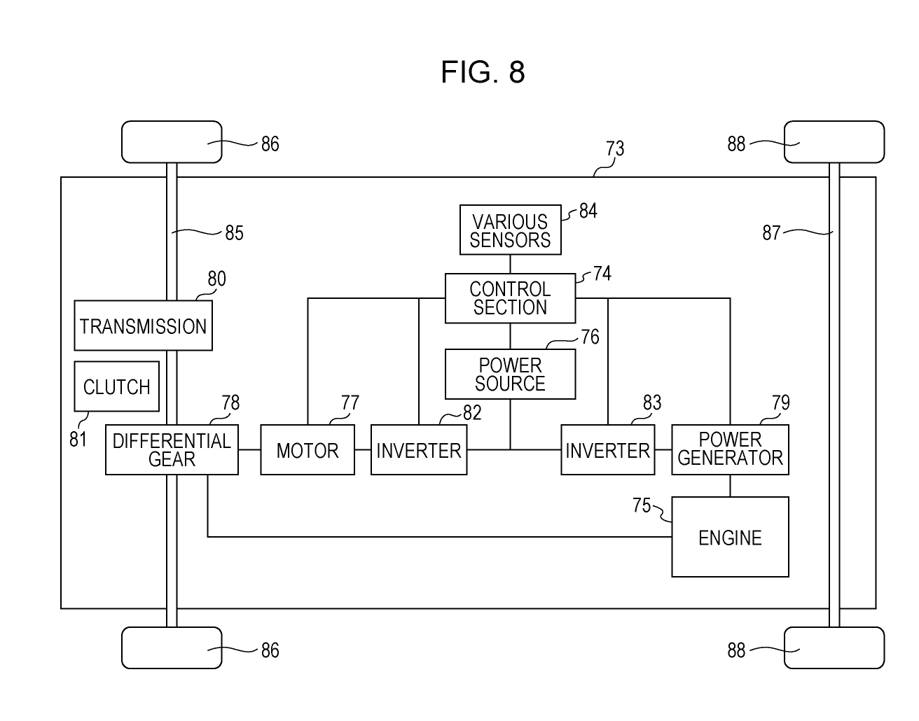

FIG. 8 shows a block configuration of a hybrid car which is an example of an electric vehicle. The electric vehicle is, for example, provided with a control section 74, an engine 75, a power source 76, a driving motor 77, a differential gear 78, a power generator 79, a transmission 80, a clutch 81, inverters 82 and 83, and various types of sensors 84 inside a metal housing 73. Other than these, the electric vehicle is provided with a front wheel driving shaft 85 and front wheels 86 which are connected with the differential gear 78 and the transmission 80 and a rear wheel driving shaft 87 and rear wheels 88.

The electric vehicle is, for example, able to run by setting one of the engine 75 and the motor 77 as a driving source. The engine 75 is a main power source and is, for example, a gasoline engine or the like. In a case of setting the engine 75 as the power source, the driving power (rotating power) of the engine 75 is, for example, transmitted to the front wheels 86 or the rear wheels 88 via the differential gear 78 which is a driving section, the transmission 80, and the clutch 81. Here, the rotating power of the engine 75 is also transmitted to the power generator 79, the power generator 79 generates alternating-current power using the rotating power, and the alternating-current power is converted into direct-current power via the inverter 83 and accumulated in the power source 76. On the other hand, in a case of setting the motor 77 which is a conversion section as the power source, the power (direct-current power) which is supplied from the power source 76 is converted into alternating-current power via the inverter 82 and the driving of the motor 77 uses the alternating-current power. The driving power (rotating power) which is converted from power from the motor 77 is, for example, transmitted to the front wheels 86 or the rear wheels 88 via the differential gear 78 which is a driving section, the transmission 80, and the clutch 81.

Here, when the electric vehicle slows down via a brake mechanism which is not shown in the diagram, the resistance power at the time of slowing down may be transmitted to the motor 77 as rotating power and the motor 77 may generate alternating-current power using the rotating power. It is preferable that the alternating-current power be converted into direct-current power via the inverter 82 and that the direct regenerative power be accumulated in the power source 76.

The control section 74 controls the operation of the entire electric vehicle and includes, for example, a CPU and the like. The power source 76 includes one or two or more secondary batteries (which are not shown in the diagram). The power source 76 may be connected with an external power source and may be able to accumulate power by receiving power supplied from the external power source. The various types of sensors 84 are, for example, used for controlling the rotation speed of the engine 75 and controlling an opening (a throttle opening) of a throttle valve which is not shown in the diagram. The various types of sensors 84 include, for example, a speed sensor, an acceleration sensor, an engine rotation speed sensor, and the like.

Here, description was given of a case where the electric vehicle is a hybrid car; however, the electric vehicle may be a vehicle (an electric car) which is operated only using the power source 76 and the motor 77 without using the engine 75.

2-4. Power Storage System

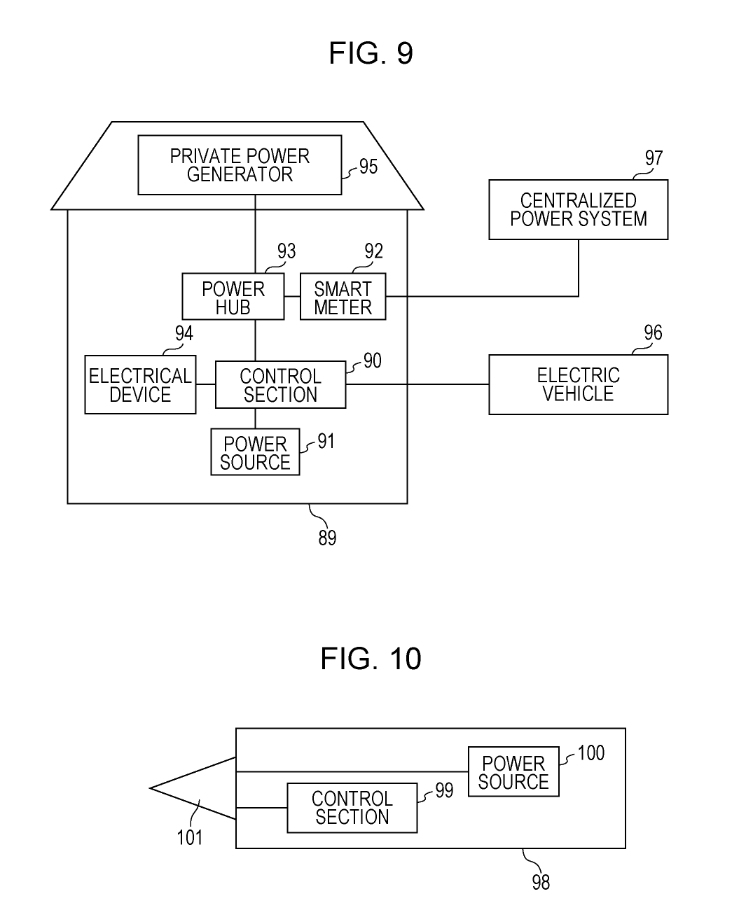

FIG. 9 represents a block configuration of a power storage system. The power storage system is, for example, provided with a control section 90, a power source 91, a smart meter 92, and a power hub 93 inside a building 89 such as a general house or a commercial building.

Here, the power source 91 is, for example, connected with an electrical device 94 which is installed inside the building 89 and is able to be connected with an electric vehicle 96 which is parked outside the building 89. In addition, the power source 91 is, for example, connected with a private power generator 95 which is installed in the building 89 via the power hub 93 and is able to be connected with an external centralized power system 97 via the smart meter 92 and the power hub 93.

Here, the electrical device 94 includes, for example, one or two or more home electrical appliances and the home electrical appliances are, for example, a refrigerator, an air-conditioner, a television, a water heater, and the like. The private power generator 95 is, for example, any one type or two types or more from among a solar power generator, a wind power generator, and the like. The electric vehicle 96 is, for example, any one type or two types or more from among an electric car, an electric motorcycle, a hybrid car, and the like. The centralized power system 97 is, for example, any one type or two types or more from among a thermal power station, a nuclear power station, a water power station, a wind power station, and the like.

The control section 90 controls the operation of the entire power storage system (which includes the usage state of the power source 91) and includes, for example, a CPU, and the like. The power source 91 includes one or two or more secondary batteries (which are not shown in the diagram). The smart meter 92 is, for example, a network-linked wattmeter which is installed in the building 89 on the power demand side and is able to communicate with the power supply side. Along with this, for example, the smart meter 92 is able to supply energy, which is efficient and stable, by controlling the balance between supply and demand in the building 89 while communicating with the outside.

In the power storage system, for example, power is accumulated in the power source 91 from the centralized power system 97 which is an external power source via the smart meter 92 and the power hub 93, and power is accumulated in the power source 91 from the private power generator 95 which is an independent power source via the power hub 93. Since the power which is accumulated in the power source 91 is supplied to the electrical device 94 and the electric vehicle 96 according to the instructions of the control section 90, it is possible to operate the electrical device 94 and it is possible to charge the electric vehicle 96. That is, the power storage system is a system which enables the accumulation and supply of power inside the building 89 using the power source 91.

It is possible to arbitrarily use the power which is accumulated in the power source 91. For this reason, for example, it is possible to accumulate power in the power source 91 from the centralized power system 97 in the middle of the night when the price of electricity is low and use the power which is accumulated in the power source 91 during the day when the price of electricity is high.

Here, the power storage system described above may be installed for each house (each family) or may be installed for a plurality of houses (a plurality of families).

2-5. Power Tool

FIG. 10 shows a block configuration of a power tool. The power tool is, for example, a power drill and is provided with a control section 99 and a power source 100 inside a tool body 98 which is formed of a plastic material or the like. For example, a drill section 101 which is a movable section is attached to the tool body 98 so as to be able to operate (rotate).

The control section 99 controls the operation of the entire power tool (which includes the usage state of the power source 100) and includes, for example, a CPU and the like. The power source 100 includes one or two or more secondary batteries (which are not shown in the diagram). The control section 99 supplies power from the power source 100 to the drill section 101 according to the operation of an operation switch which is not shown in the diagram.

### EXAMPLES

Description will be given of specific Examples of the present technology in detail.

### Experimental Examples 1-1 to 1-21

The laminate film type lithium ion secondary battery shown in FIG. 3 and FIG. 4 was manufactured according to the following steps.

In a case of manufacturing the cathode 33, firstly, a cathode mixture was made by mixing 91 parts by mass of a cathode active substance, 3 parts by mass of a cathode binding agent (polyvinylidene fluoride), and 6 parts by mass of a cathode conductive agent (graphite). A first lithium-containing compound (Li_{1.15}(Mn_{0.65}Ni_{0.22}Co_{0.13})_{0.85}O₂) was used as the cathode active substance. Subsequently, a cathode mixture slurry was made by dispersing the cathode mixture in an organic solvent (N-methyl-2-pyrrolidone). Subsequently, the cathode active substance layer 33B was formed by drying the cathode mixture slurry after uniformly coating the cathode mixture slurry on both surfaces of the cathode collector 33A in a strip form (an aluminum foil with a thickness of 12 μm). Finally, the cathode active substance layer 33B was compressed and molded using a rolling press machine.

In a case of manufacturing the anode 34, firstly, an anode mixture was made by mixing 90 parts by mass of an anode active substance and 10 parts by mass of an anode binding agent (polyvinylidene fluoride). A carbon material (graphite) was used as the anode active substance. Subsequently, an anode mixture slurry was made by dispersing the anode mixture in an organic solvent (N-methyl-2-pyrrolidone). Subsequently, the anode active substance layer 34B was formed by drying the anode mixture slurry after uniformly coating the anode mixture slurry on both surfaces of the anode collector 34A in a strip form (an aluminum foil with a thickness of 15 μm). Finally, the anode active substance layer 34B was compressed and molded using a rolling press machine.

In a case of preparing an electrolyte in a liquid form (an electrolytic solution), a mixed solution was prepared by dissolving an electrolyte salt (LiPF₆) in a mixed solvent (ethylene carbonate and ethylmethyl carbonate). In this case, the weight ratio of the composition of the mixed solvent was set to ethylene carbonate:ethylmethyl carbonate=35:65 and the content of the electrolyte salt was set to 1.2 mol/dm³(=1 mol/l) with respect to the mixed solvent. Subsequently, the mixed solution was stirred as necessary after adding the silyl compound to the mixed solution. The type and the content (wt %) of the silyl compound is as shown in Table 1.

In a case of assembling a secondary battery, firstly, the cathode lead 25 made of aluminum was welded to the cathode 33 (the cathode collector 33A) and the anode lead 26 made of copper was welded to the anode 34 (the anode collector 34A). Subsequently, after manufacturing the winding electrode body 30 by winding in a longitudinal direction after laminating the cathode 33 and the anode 34 via the separator 35 (a polyethylene film with a thickness of 20 μm), the protective tape 37 was bonded with the outermost peripheral section thereof. Subsequently, after bending the external member 40 so as to interpose the winding electrode body 30, the outer peripheral edge sections on three sides of the external member 40 were heated and fused to each other. Due to this, the winding electrode body 30 was stored inside the external member 40 in a bag form. The external member 40 is a moisture-resistant aluminum laminate film where a nylon film with a thickness of 25 μm, an aluminum foil with a thickness of 40 μm, and a polypropylene film with a thickness of 30 μm were laminated in this order from the outside. Finally, after injecting the electrolytic solution inside the external member 40 and impregnating the electrolytic solution into the separator 35, the one remaining side of the external member 40 was heated and fused under a reduced pressure environment. In this case, the adhesive film 41 (an acid-modified propylene film with a thickness of 50 μm) was inserted between the cathode lead 31 and the anode lead 32, and the external member 40.

When the battery characteristics (cycle characteristics) of the secondary battery were examined, the results shown in Table 1 were obtained.

In a case of examining the cycle characteristics, firstly, the secondary battery was charged and discharged for one cycle under a normal temperature environment (23° C.) in order to stabilize the battery state. Subsequently, the discharging capacity in the second cycle was measured by charging and discharging the secondary battery again under the same environment. Subsequently, the discharging capacity in the hundredth cycle was measured by charging and discharging the secondary battery until the total number of cycles was a hundred cycles under the same environment. From this result, a capacity maintaining ratio (%)=(discharging capacity in the hundredth cycle/discharging capacity in the second cycle)×100 was calculated. During charging, after charging with a current of 0.2 C until the battery voltage reached a specific voltage (the upper limit voltage), the secondary battery was charged with the same voltage until the current density reached 0.05 C. During discharging, the secondary battery was discharged with a current of 0.2 C until the battery voltage reached a specific voltage (the lower limit voltage). Each of the values of the upper limit voltage and the lower limit voltage is as shown in Table 1. Here, “0.2 C” is a current value which completes discharging of the battery capacity (the theoretical capacity) in 5 hours and “0.05 C” is a current value which completes discharging of the battery capacity (the theoretical capacity) in 20 hours.

TABLE 1
Electrolyte = Electrolytic Solution, Upper Limit Voltage =
4.55 V, Lower Limit Voltage = 2 V

| | Cathode | Anode | | | Capacity |
|---|---|---|---|---|---|
| Experi- | Active | Active | Silyl Compound | | Main- |
| mental | Substance | Substance | | Content | taining |
| Example | Type | Type | Type | (wt %) | Ratio (%) |
| 1-1 | Li_{1.15}(Mn_{0.65}Ni_{0.22}Co_{0.13})_{0.85}O₂ | Graphite | Formula | 0.01 | 43 |
| 1-2 | | | (4-1) | 0.1 | 50.6 |
| 1-3 | | | | 1 | 73.3 |
| 1-4 | | | | 3 | 47.6 |
| 1-5 | | | Formula | 0.01 | 47.2 |
| 1-6 | | | (4-2) | 0.1 | 77.5 |
| 1-7 | | | | 1 | 95.5 |
| 1-8 | | | | 3 | 62 |
| 1-9 | | | Formula | 0.01 | 48.1 |
| 1-10 | | | (4-3) | 0.1 | 77.1 |
| 1-11 | | | | 1 | 89.2 |
| 1-12 | | | | 3 | 62.8 |
| 1-13 | | | Formula | 0.01 | 43.2 |
| 1-14 | | | (4-4) | 0.1 | 62.2 |
| 1-15 | | | | 1 | 78.6 |
| 1-16 | | | | 3 | 50 |
| 1-17 | | | Formula | 0.01 | 43.9 |
| 1-18 | | | (4-5) | 0.1 | 61.2 |
| 1-19 | | | | 1 | 80.8 |
| 1-20 | | | | 3 | 47.3 |
| 1-21 | Li_{1.15}(Mn_{0.65}Ni_{0.22}Co_{0.13})_{0.85}O₂ | Graphite | — | — | 40.8 |

The secondary battery which used the first lithium-containing compound as the cathode active substance was charged and discharged under high charging voltage conditions. In this case, when the electrolytic solution included a silyl compound (experimental examples 1-1 to 1-20), the capacity maintaining ratio greatly increased without depending on the type of the silyl compound compared to a case where the electrolytic solution did not include a silyl compound (experimental example 1-21).

In particular, when the content of the silyl compound in the electrolytic solution was 0.01 wt % to 3 wt %, a sufficiently high capacity maintaining ratio was obtained.

### Experimental Examples 2-1 to 2-21 and 3-1 to 3-21

As shown in Table 2 and Table 3, a secondary battery was manufactured and the battery characteristics were examined according to the same steps apart from changing the type of the anode active substance.

In a case of manufacturing the anode 34, firstly, an anode mixture was made by mixing 90 parts by mass of an anode active substance, 5 parts by mass of a material for a binding agent (polyamic acid which is a precursor body of polyimide), and 5 parts by mass of an anode conductive agent (graphite). Silicon and a silicon iron alloy (FeSi₂) which are metal-based materials were used as the anode active substance. Each of the average particle diameters (median diameter D50) of the silicon powder and the silicon iron alloy powder was 5 μm. Subsequently, an anode mixture slurry was made by dispersing the anode mixture in an organic solvent (N-methyl-2-pyrrolidone). Subsequently, a mixture layer was formed by drying the anode mixture slurry after uniformly coating the anode mixture slurry on both surfaces of the anode collector 34A in a strip form (a copper foil with a thickness of 15 μm). Subsequently, the mixture layer was compressed and molded using a rolling press machine. Finally, the mixture layer was heated (400° C.×12 hours) in a vacuum atmosphere. Due to this, since an anode binding agent (polyimide) was formed, the anode active substance layer 34B was formed.

TABLE 2
Electrolyte = Electrolytic Solution, Upper Limit Voltage =
4.55 V, Lower Limit Voltage = 2 V

| | Cathode | Anode | | | Capacity |
|---|---|---|---|---|---|
| Experi- | Active | Active | Silyl Compound | | Main- |
| mental | Substance | Substance | | Content | taining |
| Example | Type | Type | Type | (wt %) | Ratio (%) |
| 2-1 | Li_{1.15}(Mn_{0.65}Ni_{0.22}Co_{0.13})_{0.85}O₂ | Silicon | Formula | 0.01 | 39.4 |
| 2-2 | | | (4-1) | 0.1 | 44.9 |
| 2-3 | | | | 1 | 63.9 |
| 2-4 | | | | 3 | 43.4 |
| 2-5 | | | Formula | 0.01 | 40.5 |
| 2-6 | | | (4-2) | 0.1 | 68.2 |
| 2-7 | | | | 1 | 84.6 |
| 2-8 | | | | 3 | 54.2 |
| 2-9 | | | Formula | 0.01 | 42.4 |
| 2-10 | | | (4-3) | 0.1 | 67.3 |
| 2-11 | | | | 1 | 82.7 |
| 2-12 | | | | 3 | 56.3 |
| 2-13 | | | Formula | 0.01 | 38.9 |
| 2-14 | | | (4-4) | 0.1 | 57.8 |
| 2-15 | | | | 1 | 73 |
| 2-16 | | | | 3 | 46.1 |
| 2-17 | | | Formula | 0.01 | 38.3 |
| 2-18 | | | (4-5) | 0.1 | 56.3 |
| 2-19 | | | | 1 | 69.6 |
| 2-20 | | | | 3 | 44.2 |
| 2-21 | Li_{1.15}(Mn_{0.65}Ni_{0.22}Co_{0.13})_{0.85}O₂ | Silicon | — | — | 36.8 |

TABLE 3
Electrolyte = Electrolytic Solution, Upper Limit Voltage =
4.55 V, Lower Limit Voltage = 2 V

| | Cathode | Anode | | | Capacity |
|---|---|---|---|---|---|
| Experi- | Active | Active | Silyl Compound | | Main- |
| mental | Substance | Substance | | Content | taining |
| Example | Type | Type | Type | (wt %) | Ratio (%) |
| 3-1 | Li_{1.15}(Mn_{0.65}Ni_{0.22}Co_{0.13})_{0.85}O₂ | Silicon iron | Formula | 0.01 | 40.8 |
| 3-2 | | alloy | (4-1) | 0.1 | 48.1 |
| 3-3 | | | | 1 | 69.6 |
| 3-4 | | | | 3 | 45.2 |
| 3-5 | | | Formula | 0.01 | 44.8 |
| 3-6 | | | (4-2) | 0.1 | 73.6 |
| 3-7 | | | | 1 | 90.7 |
| 3-8 | | | | 3 | 58.9 |
| 3-9 | | | Formula | 0.01 | 45.7 |
| 3-10 | | | (4-3) | 0.1 | 73.2 |
| 3-11 | | | | 1 | 84.7 |
| 3-12 | | | | 3 | 59.7 |
| 3-13 | | | Formula | 0.01 | 41.1 |
| 3-14 | | | (4-4) | 0.1 | 59.1 |
| 3-15 | | | | 1 | 74.7 |
| 3-16 | | | | 3 | 47.5 |
| 3-17 | | | Formula | 0.01 | 41.7 |
| 3-18 | | | (4-5) | 0.1 | 58.1 |
| 3-19 | | | | 1 | 76.8 |
| 3-20 | | | | 3 | 44.9 |
| 3-21 | Li_{1.15}(Mn_{0.65}Ni_{0.22}Co_{0.13})_{0.85}O₂ | Silicon iron | — | — | 38.7 |
| | | alloy | | | |

In a case of using a metal-based material as the anode active substance (Table 2 and Table 3), the same results as in the case of using a carbon material (Table 1) were also obtained. That is, in a case of charging and discharging the secondary battery, which used the first lithium-containing compound as the cathode active substance, under the high charging voltage condition, the capacity maintaining ratio greatly increased when the electrolytic solution included a silyl compound.

### Experimental Examples 4-1 to 4-21, 5-1 to 5-21, and 6-1 to 6-21

As shown in Table 4 to Table 6, a secondary battery was manufactured and the battery characteristics were examined according to the same steps apart from changing the type of the electrolyte.

In a case of forming an electrolyte in a gel form (the electrolytic layer 36), firstly, a mixed solution in a zol form was prepared by dissolving an electrolyte salt (LiPF₆) in a mixed solvent (ethylene carbonate and propylene carbonate). In this case, the weight ratio of the composition of the mixture solvent was set to ethylene carbonate:ethylmethyl carbonate=50:50 and the content of the electrolyte salt was set to 1 mol/kg with respect to the mixed solvent. Subsequently, as shown in Table 4 to Table 6, the mixed solution was stirred as necessary after adding a silyl compound to the mixed solution. Subsequently, a precursor solution was prepared by mixing 30 parts by mass of an electrolytic solution, 10 parts by mass of a polymer compound (a copolymer of vinylidene fluoride and hexafluoropropylene), and 60 parts by mass of an organic solvent (dimethyl carbonate). The copolymerization amount of hexafluoropropylene in the copolymer was 6.9 wt %. Finally, the precursor solution was dried after coating the precursor solution on both surfaces of each of the cathode 33 and the anode 34. Due to this, the electrolytic layer 36 in a gel form was formed.

TABLE 4
Electrolyte = Electrolytic Layer, Upper Limit Voltage =
4.55 V, Lower Limit Voltage = 2 V

| | Cathode | Anode | | | Capacity |
|---|---|---|---|---|---|
| Experi- | Active | Active | Silyl Compound | | Main- |
| mental | Substance | Substance | | Content | taining |
| Example | Type | Type | Type | (wt %) | Ratio (%) |
| 4-1 | Li_{1.15}(Mn_{0.65}Ni_{0.22}Co_{0.13})_{0.85}O₂ | Graphite | Formula | 0.01 | 45.2 |
| 4-2 | | | (4-1) | 0.1 | 50.2 |
| 4-3 | | | | 1 | 70.4 |
| 4-4 | | | | 3 | 48.5 |
| 4-5 | | | Formula | 0.01 | 48.1 |
| 4-6 | | | (4-2) | 0.1 | 75.1 |
| 4-7 | | | | 1 | 95.6 |
| 4-8 | | | | 3 | 63.7 |
| 4-9 | | | Formula | 0.01 | 45.6 |
| 4-10 | | | (4-3) | 0.1 | 75.6 |
| 4-11 | | | | 1 | 92.6 |
| 4-12 | | | | 3 | 62.8 |
| 4-13 | | | Formula | 0.01 | 43.3 |
| 4-14 | | | (4-4) | 0.1 | 61.5 |
| 4-15 | | | | 1 | 79.5 |
| 4-16 | | | | 3 | 49.5 |
| 4-17 | | | Formula | 0.01 | 43.6 |
| 4-18 | | | (4-5) | 0.1 | 62.9 |
| 4-19 | | | | 1 | 80 |
| 4-20 | | | | 3 | 48.9 |
| 4-21 | Li_{1.15}(Mn_{0.65}Ni_{0.22}Co_{0.13})_{0.85}O₂ | Graphite | — | — | 35.1 |

TABLE 5
Electrolyte = Electrolytic Layer, Upper Limit Voltage =
4.55 V, Lower Limit Voltage = 2 V

| | Cathode | Anode | | | Capacity |
|---|---|---|---|---|---|
| Experi- | Active | Active | Silyl Compound | | Main- |
| mental | Substance | Substance | | Content | taining |
| Example | Type | Type | Type | (wt %) | Ratio (%) |
| 5-1 | Li_{1.15}(Mn_{0.65}Ni_{0.22}Co_{0.13})_{0.85}O₂ | Silicon | Formula | 0.01 | 40.4 |
| 5-2 | | | (4-1) | 0.1 | 44.9 |
| 5-3 | | | | 1 | 63.5 |
| 5-4 | | | | 3 | 45.3 |
| 5-5 | | | Formula | 0.01 | 42.2 |
| 5-6 | | | (4-2) | 0.1 | 65.4 |
| 5-7 | | | | 1 | 85.8 |
| 5-8 | | | | 3 | 54.9 |
| 5-9 | | | Formula | 0.01 | 40.6 |
| 5-10 | | | (4-3) | 0.1 | 65.4 |
| 5-11 | | | | 1 | 83.2 |
| 5-12 | | | | 3 | 55.4 |
| 5-13 | | | Formula | 0.01 | 38.2 |
| 5-14 | | | (4-4) | 0.1 | 56.6 |
| 5-15 | | | | 1 | 71.5 |
| 5-16 | | | | 3 | 44.7 |
| 5-17 | | | Formula | 0.01 | 41.3 |
| 5-18 | | | (4-5) | 0.1 | 58.6 |
| 5-19 | | | | 1 | 69.5 |
| 5-20 | | | | 3 | 43.6 |
| 5-21 | Li_{1.15}(Mn_{0.65}Ni_{0.22}Co_{0.13})_{0.85}O₂ | Silicon | — | — | 32.2 |

TABLE 6
Electrolyte = Electrolytic Layer, Upper Limit Voltage =
4.55 V, Lower Limit Voltage = 2 V

| | Cathode | Anode | | | Capacity |
|---|---|---|---|---|---|
| Experi- | Active | Active | Silyl Compound | | Main- |
| mental | Substance | Substance | | Content | taining |
| Example | Type | Type | Type | (wt %) | Ratio (%) |
| 6-1 | Li_{1.15}(Mn_{0.65}Ni_{0.22}Co_{0.13})_{0.85}O₂ | Silicon iron | Formula | 0.01 | 44.1 |
| 6-2 | | alloy | (4-1) | 0.1 | 48 |
| 6-3 | | | | 1 | 67.2 |
| 6-4 | | | | 3 | 45.6 |
| 6-5 | | | Formula | 0.01 | 45.4 |
| 6-6 | | | (4-2) | 0.1 | 71.1 |
| 6-7 | | | | 1 | 92.8 |
| 6-8 | | | | 3 | 60.5 |
| 6-9 | | | Formula | 0.01 | 43.1 |
| 6-10 | | | (4-3) | 0.1 | 70.8 |
| 6-11 | | | | 1 | 87.2 |
| 6-12 | | | | 3 | 61.2 |
| 6-13 | | | Formula | 0.01 | 42.7 |
| 6-14 | | | (4-4) | 0.1 | 60.4 |
| 6-15 | | | | 1 | 77.3 |
| 6-16 | | | | 3 | 45.7 |
| 6-17 | | | Formula | 0.01 | 40.9 |
| 6-18 | | | (4-5) | 0.1 | 60.2 |
| 6-19 | | | | 1 | 76.3 |
| 6-20 | | | | 3 | 47.5 |
| 6-21 | Li_{1.15}(Mn_{0.65}Ni_{0.22}Co_{0.13})_{0.85}O₂ | Silicon iron | — | — | 34.2 |
| | | alloy | | | |

Also in a case of using an electrolyte in a gel form (the electrolytic layer 36) (Table 4 to Table 6), the same results as in the case of using an electrolyte in a liquid form (an electrolytic solution) (Table 1 to Table 3) were obtained. That is, in a case of charging and discharging the secondary battery, which used the first lithium-containing compound as the cathode active substance, under the high charging voltage condition, the capacity maintaining ratio greatly increased when the electrolytic solution included a silyl compound.

### Experimental Examples 7-1 to 7-18, 8-1 to 8-18, 9-1 to 9-18, 10-1 to 10-18, 11-1 to 11-18, and 12-1 to 12-18

As shown in Table 7 to Table 12, a secondary battery was manufactured and the battery characteristics were examined according to the same steps apart from changing the type of the cathode active substance. A second lithium-containing compound (LiCoO₂ and Li(Ni_{0.5}Co_{0.2}Mn_{0.3})O₂) and a third lithium-containing compound (NiMn_{1.5}Ni_{0.5}O₄) were used as the cathode active substance.

TABLE 7
Electrolyte = Electrolytic Solution, Upper Limit Voltage =
4.5 V, Lower Limit Voltage = 3 V

| | Cathode | Anode | | | Capacity |
|---|---|---|---|---|---|
| Experi- | Active | Active | Silyl Compound | | Main- |
| mental | Substance | Substance | | Content | taining |
| Example | Type | Type | Type | (wt %) | Ratio (%) |
| 7-1 | LiCoO₂ | Graphite | Formula | 1 | 73.1 |
| | | | (4-1) | | |
| 7-2 | | | Formula | 1 | 79.4 |
| | | | (4-2) | | |
| 7-3 | | | Formula | 1 | 77.5 |
| | | | (4-3) | | |
| 7-4 | | | Formula | 1 | 76.8 |
| | | | (4-4) | | |
| 7-5 | | | Formula | 1 | 75.5 |
| | | | (4-5) | | |
| 7-6 | LiCoO₂ | Silicon | Formula | 1 | 65.5 |
| | | | (4-1) | | |
| 7-7 | | | Formula | 1 | 71.3 |
| | | | (4-2) | | |
| 7-8 | | | Formula | 1 | 69.7 |
| | | | (4-3) | | |
| 7-9 | | | Formula | 1 | 68.9 |
| | | | (4-4) | | |
| 7-10 | | | Formula | 1 | 67.6 |
| | | | (4-5) | | |
| 7-11 | LiCoO₂ | Silicon iron | Formula | 1 | 62.2 |
| | | alloy | (4-1) | | |
| 7-12 | | | Formula | 1 | 67.7 |
| | | | (4-2) | | |
| 7-13 | | | Formula | 1 | 66.2 |
| | | | (4-3) | | |
| 7-14 | | | Formula | 1 | 65.4 |
| | | | (4-4) | | |
| 7-15 | | | Formula | 1 | 64.2 |
| | | | (4-5) | | |
| 7-16 | LiCoO₂ | Graphite | — | — | 68.7 |
| 7-17 | LiCoO₂ | Silicon | — | — | 61.4 |
| 7-18 | LiCoO₂ | Silicon iron | — | — | 58.2 |
| | | alloy | | | |

TABLE 8
Electrolyte = Electrolytic Solution, Upper Limit Voltage =
4.5 V, Lower Limit Voltage = 3 V

| | Cathode | Anode | | | Capacity |
|---|---|---|---|---|---|
| Experi- | Active | Active | Silyl Compound | | Main- |
| mental | Substance | Substance | | Content | taining |
| Example | Type | Type | Type | (wt %) | Ratio (%) |
| 8-1 | Li(Ni_{0.5}Co_{0.2}Mn_{0.3})O₂ | Graphite | Formula | 1 | 60.6 |
| | | | (4-1) | | |
| 8-2 | | | Formula | 1 | 72.2 |
| | | | (4-2) | | |
| 8-3 | | | Formula | 1 | 68.4 |
| | | | (4-3) | | |
| 8-4 | | | Formula | 1 | 66 |
| | | | (4-4) | | |
| 8-5 | | | Formula | 1 | 63.8 |
| | | | (4-5) | | |
| 8-6 | Li(Ni_{0.5}Co_{0.2}Mn_{0.3})O₂ | Silicon | Formula | 1 | 51.7 |
| | | | (4-1) | | |
| 8-7 | | | Formula | 1 | 60.2 |
| | | | (4-2) | | |
| 8-8 | | | Formula | 1 | 61.2 |
| | | | (4-3) | | |
| 8-9 | | | Formula | 1 | 57.5 |
| | | | (4-4) | | |
| 8-10 | | | Formula | 1 | 51.9 |
| | | | (4-5) | | |
| 8-11 | Li(Ni_{0.5}Co_{0.2}Mn_{0.3})O₂ | Silicon iron | Formula | 1 | 46.1 |
| | | alloy | (4-1) | | |
| 8-12 | | | Formula | 1 | 56.8 |
| | | | (4-2) | | |
| 8-13 | | | Formula | 1 | 53.7 |
| | | | (4-3) | | |
| 8-14 | | | Formula | 1 | 49.5 |
| | | | (4-4) | | |
| 8-15 | | | Formula | 1 | 46.1 |
| | | | (4-5) | | |
| 8-16 | Li(Ni_{0.5}Co_{0.2}Mn_{0.3})O₂ | Graphite | — | — | 54.7 |
| 8-17 | Li(Ni_{0.5}Co_{0.2}Mn_{0.3})O₂ | Silicon | — | — | 48.2 |
| 8-18 | Li(Ni_{0.5}Co_{0.2}Mn_{0.3})O₂ | Silicon iron | — | — | 42 |
| | | alloy | | | |

TABLE 9
Electrolyte = Electrolytic Solution, Upper Limit Voltage =
4.95 V, Lower Limit Voltage = 3 V

| | Cathode | Anode | | | Capacity |
|---|---|---|---|---|---|
| Experi- | Active | Active | Silyl Compound | | Main- |
| mental | Substance | Substance | | Content | taining |
| Example | Type | Type | Type | (wt %) | Ratio (%) |
| 9-1 | LiMn_{1.5}Ni_{0.5}O₄ | Graphite | Formula | 1 | 51 |
| | | | (4-1) | | |
| 9-2 | | | Formula | 1 | 63.6 |
| | | | (4-2) | | |
| 9-3 | | | Formula | 1 | 61.8 |
| | | | (4-3) | | |
| 9-4 | | | Formula | 1 | 54.8 |
| | | | (4-4) | | |
| 9-5 | | | Formula | 1 | 54.2 |
| | | | (4-5) | | |
| 9-6 | LiMn_{1.5}Ni_{0.5}O₄ | Silicon | Formula | 1 | 42.1 |
| | | | (4-1) | | |
| 9-7 | | | Formula | 1 | 53.6 |
| | | | (4-2) | | |
| 9-8 | | | Formula | 1 | 49.6 |
| | | | (4-3) | | |
| 9-9 | | | Formula | 1 | 44.9 |
| | | | (4-4) | | |
| 9-10 | | | Formula | 1 | 48 |
| | | | (4-5) | | |
| 9-11 | LiMn_{1.5}Ni_{0.5}O₄ | Silicon iron | Formula | 1 | 36 |
| | | alloy | (4-1) | | |
| 9-12 | | | Formula | 1 | 46.8 |
| | | | (4-2) | | |
| 9-13 | | | Formula | 1 | 46 |
| | | | (4-3) | | |
| 9-14 | | | Formula | 1 | 39 |
| | | | (4-4) | | |
| 9-15 | | | Formula | 1 | 41.2 |
| | | | (4-5) | | |
| 9-16 | LiMn_{1.5}Ni_{0.5}O₄ | Graphite | — | — | 42.1 |
| 9-17 | LiMn_{1.5}Ni_{0.5}O₄ | Silicon | — | — | 37.8 |
| 9-18 | LiMn_{1.5}Ni_{0.5}O₄ | Silicon iron | — | — | 33.7 |
| | | alloy | | | |

TABLE 10
Electrolyte = Electrolytic Layer, Upper Limit Voltage =
4.5 V, Lower Limit Voltage = 3 V

| | Cathode | Anode | | | Capacity |
|---|---|---|---|---|---|
| Experi- | Active | Active | Silyl Compound | | Main- |
| mental | Substance | Substance | | Content | taining |
| Example | Type | Type | Type | (wt %) | Ratio (%) |
| 10-1 | LiCoO₂ | Graphite | Formula | 1 | 74.6 |
| | | | (4-1) | | |
| 10-2 | | | Formula | 1 | 80.1 |
| | | | (4-2) | | |
| 10-3 | | | Formula | 1 | 76.2 |
| | | | (4-3) | | |
| 10-4 | | | Formula | 1 | 74.1 |
| | | | (4-4) | | |
| 10-5 | | | Formula | 1 | 74.1 |
| | | | (4-5) | | |
| 10-6 | LiCoO₂ | Silicon | Formula | 1 | 66.6 |
| | | | (4-1) | | |
| 10-7 | | | Formula | 1 | 71.3 |
| | | | (4-2) | | |
| 10-8 | | | Formula | 1 | 68.5 |
| | | | (4-3) | | |
| 10-9 | | | Formula | 1 | 66.1 |
| | | | (4-4) | | |
| 10-10 | | | Formula | 1 | 66.3 |
| | | | (4-5) | | |
| 10-11 | LiCoO₂ | Silicon iron | Formula | 1 | 63.2 |
| | | alloy | (4-1) | | |
| 10-12 | | | Formula | 1 | 67.7 |
| | | | (4-2) | | |
| 10-13 | | | Formula | 1 | 65 |
| | | | (4-3) | | |
| 10-14 | | | Formula | 1 | 62.8 |
| | | | (4-4) | | |
| 10-15 | | | Formula | 1 | 62.9 |
| | | | (4-5) | | |
| 10-16 | LiCoO₂ | Graphite | — | — | 63.4 |
| 10-17 | LiCoO₂ | Silicon | — | — | 56.6 |
| 10-18 | LiCoO₂ | Silicon iron | — | — | 53.8 |
| | | alloy | | | |

TABLE 11
Electrolyte = Electrolytic Layer, Upper Limit Voltage =
4.5 V, Lower Limit Voltage = 3 V

| | Cathode | Anode | | | Capacity |
|---|---|---|---|---|---|
| Experi- | Active | Active | Silyl Compound | | Main- |
| mental | Substance | Substance | | Content | taining |
| Example | Type | Type | Type | (wt %) | Ratio (%) |
| 11-1 | Li(Ni_{0.5}Co_{0.2}Mn_{0.3})O₂ | Graphite | Formula | 1 | 59.5 |
| | | | (4-1) | | |
| 11-2 | | | Formula | 1 | 69.7 |
| | | | (4-2) | | |
| 11-3 | | | Formula | 1 | 67.5 |
| | | | (4-3) | | |
| 11-4 | | | Formula | 1 | 64.9 |
| | | | (4-4) | | |
| 11-5 | | | Formula | 1 | 62.2 |
| | | | (4-5) | | |
| 11-6 | Li(Ni_{0.5}Co_{0.2}Mn_{0.3})O₂ | Silicon | Formula | 1 | 48.5 |
| | | | (4-1) | | |
| 11-7 | | | Formula | 1 | 61.5 |
| | | | (4-2) | | |
| 11-8 | | | Formula | 1 | 54.1 |
| | | | (4-3) | | |
| 11-9 | | | Formula | 1 | 58.4 |
| | | | (4-4) | | |
| 11-10 | | | Formula | 1 | 52.3 |
| | | | (4-5) | | |
| 11-11 | Li(Ni_{0.5}Co_{0.2}Mn_{0.3})O₂ | Silicon iron | Formula | 1 | 45.2 |
| | | alloy | (4-1) | | |
| 11-12 | | | Formula | 1 | 54.5 |
| | | | (4-2) | | |
| 11-13 | | | Formula | 1 | 48.7 |
| | | | (4-3) | | |
| 11-14 | | | Formula | 1 | 52.7 |
| | | | (4-4) | | |
| 11-15 | | | Formula | 1 | 45.3 |
| | | | (4-5) | | |
| 11-16 | Li(Ni_{0.5}Co_{0.2}Mn_{0.3})O₂ | Graphite | — | — | 51.4 |
| 11-17 | Li(Ni_{0.5}Co_{0.2}Mn_{0.3})O₂ | Silicon | — | — | 43.3 |
| 11-18 | Li(Ni_{0.5}Co_{0.2}Mn_{0.3})O₂ | Silicon iron | — | — | 38.3 |
| | | alloy | | | |

TABLE 12
Electrolyte = Electrolytic Layer, Upper Limit Voltage =
4.95 V, Lower Limit Voltage = 3 V

| | Cathode | Anode | | | Capacity |
|---|---|---|---|---|---|
| Experi- | Active | Active | Silyl Compound | | Main- |
| mental | Substance | Substance | | Content | taining |
| Example | Type | Type | Type | (wt %) | Ratio (%) |
| 12-1 | LiMn_{1.5}Ni_{0.5}O₄ | Graphite | Formula | 1 | 51.6 |
| | | | (4-1) | | |
| 12-2 | | | Formula | 1 | 63.5 |
| | | | (4-2) | | |
| 12-3 | | | Formula | 1 | 61.4 |
| | | | (4-3) | | |
| 12-4 | | | Formula | 1 | 55.5 |
| | | | (4-4) | | |
| 12-5 | | | Formula | 1 | 54.4 |
| | | | (4-5) | | |
| 12-6 | LiMn_{1.5}Ni_{0.5}O₄ | Silicon | Formula | 1 | 44.1 |
| | | | (4-1) | | |
| 12-7 | | | Formula | 1 | 56.6 |
| | | | (4-2) | | |
| 12-8 | | | Formula | 1 | 54.4 |
| | | | (4-3) | | |
| 12-9 | | | Formula | 1 | 47.8 |
| | | | (4-4) | | |
| 12-10 | | | Formula | 1 | 46.8 |
| | | | (4-5) | | |
| 12-11 | LiMn_{1.5}Ni_{0.5}O₄ | Silicon iron | Formula | 1 | 40.3 |
| | | alloy | (4-1) | | |
| 12-12 | | | Formula | 1 | 51.5 |
| | | | (4-2) | | |
| 12-13 | | | Formula | 1 | 50.8 |
| | | | (4-3) | | |
| 12-14 | | | Formula | 1 | 44.9 |
| | | | (4-4) | | |
| 12-15 | | | Formula | 1 | 42 |
| | | | (4-5) | | |
| 12-16 | LiMn_{1.5}Ni_{0.5}O₄ | Graphite | — | — | 40.7 |
| 12-17 | LiMn_{1.5}Ni_{0.5}O₄ | Silicon | — | — | 35.8 |
| 12-18 | LiMn_{1.5}Ni_{0.5}O₄ | Silicon iron | — | — | 30.5 |
| | | alloy | | | |

In a case of charging and discharging the secondary battery, which used a second lithium-containing compound and a third lithium-containing compound as the cathode active substance, under the high charging voltage condition (Table 7 to Table 12), the same results as in the case of using a first lithium-containing compound (Table 1 to Table 6) were obtained. That is, the capacity maintaining ratio greatly increased when the electrolytic solution included a silyl compound.

### Experimental Examples 13-1 to 13-18, 14-1 to 14-18, 15-1 to 15-18, and 16-1 to 16-18

As shown in Table 13 to Table 16, a secondary battery was manufactured and the battery characteristics were examined according to the same steps apart from using a material other than a specific lithium-containing compound as the cathode active substance. A lithium transition metal phosphate compound (LiFePO₄) and a lithium transition metal composition oxide (LiMn₂O₄) were used as the other material.

TABLE 13
Electrolyte = Electrolytic Solution, Upper Limit Voltage =
3.6 V, Lower Limit Voltage = 2 V

| | Cathode | Anode | | | Capacity |
|---|---|---|---|---|---|
| Experi- | Active | Active | Silyl Compound | | Main- |
| mental | Substance | Substance | | Content | taining |
| Example | Type | Type | Type | (wt %) | Ratio (%) |
| 13-1 | LiFePO₄ | Graphite | Formula | 1 | 76.7 |
| | | | (4-1) | | |
| 13-2 | | | Formula | 1 | 77.3 |
| | | | (4-2) | | |
| 13-3 | | | Formula | 1 | 77.6 |
| | | | (4-3) | | |
| 13-4 | | | Formula | 1 | 80.3 |
| | | | (4-4) | | |
| 13-5 | | | Formula | 1 | 79 |
| | | | (4-5) | | |
| 13-6 | LiFePO₄ | Silicon | Formula | 1 | 66.1 |
| | | | (4-1) | | |
| 13-7 | | | Formula | 1 | 63.3 |
| | | | (4-2) | | |
| 13-8 | | | Formula | 1 | 68.8 |
| | | | (4-3) | | |
| 13-9 | | | Formula | 1 | 69.4 |
| | | | (4-4) | | |
| 13-10 | | | Formula | 1 | 64.2 |
| | | | (4-5) | | |
| 13-11 | LiFePO₄ | Silicon iron | Formula | 1 | 61.8 |
| | | alloy | (4-1) | | |
| 13-12 | | | Formula | 1 | 54.5 |
| | | | (4-2) | | |
| 13-13 | | | Formula | 1 | 65.1 |
| | | | (4-3) | | |
| 13-14 | | | Formula | 1 | 64 |
| | | | (4-4) | | |
| 13-15 | | | Formula | 1 | 60.8 |
| | | | (4-5) | | |
| 13-16 | LiFePO₄ | Graphite | — | — | 78 |
| 13-17 | LiFePO₄ | Silicon | — | — | 66.5 |
| 13-18 | LiFePO₄ | Silicon iron | — | — | 60.4 |
| | | alloy | | | |

TABLE 14
Electrolyte = Electrolytic Solution, Upper Limit Voltage =
4.2 V, Lower Limit Voltage = 3 V

| | Cathode | Anode | | | Capacity |
|---|---|---|---|---|---|
| Experi- | Active | Active | Silyl Compound | | Main- |
| mental | Substance | Substance | | Content | taining |
| Example | Type | Type | Type | (wt %) | Ratio (%) |
| 14-1 | LiMn₂O₄ | Graphite | Formula | 1 | 78.9 |
| | | | (4-1) | | |
| 14-2 | | | Formula | 1 | 77.8 |
| | | | (4-2) | | |
| 14-3 | | | Formula | 1 | 74.6 |
| | | | (4-3) | | |
| 14-4 | | | Formula | 1 | 76.4 |
| | | | (4-4) | | |
| 14-5 | | | Formula | 1 | 75.4 |
| | | | (4-5) | | |
| 14-6 | LiMn₂O₄ | Silicon | Formula | 1 | 64 |
| | | | (4-1) | | |
| 14-7 | | | Formula | 1 | 70 |
| | | | (4-2) | | |
| 14-8 | | | Formula | 1 | 62 |
| | | | (4-3) | | |
| 14-9 | | | Formula | 1 | 63.6 |
| | | | (4-4) | | |
| 14-10 | | | Formula | 1 | 66.2 |
| | | | (4-5) | | |
| 14-11 | LiMn₂O₄ | Silicon iron | Formula | 1 | 59 |
| | | alloy | (4-1) | | |
| 14-12 | | | Formula | 1 | 59.7 |
| | | | (4-2) | | |
| 14-13 | | | Formula | 1 | 56.4 |
| | | | (4-3) | | |
| 14-14 | | | Formula | 1 | 56.9 |
| | | | (4-4) | | |
| 14-15 | | | Formula | 1 | 59.2 |
| | | | (4-5) | | |
| 14-16 | LiMn₂O₄ | Graphite | — | — | 75 |
| 14-17 | LiMn₂O₄ | Silicon | — | — | 67.4 |
| 14-18 | LiMn₂O₄ | Silicon iron | — | — | 61.5 |
| | | alloy | | | |

TABLE 15
Electrolyte = Electrolytic Layer, Upper Limit Voltage =
3.6 V, Lower Limit Voltage = 2 V

| | Cathode | Anode | | | Capacity |
|---|---|---|---|---|---|
| Experi- | Active | Active | Silyl Compound | | Main- |
| mental | Substance | Substance | | Content | taining |
| Example | Type | Type | Type | (wt %) | Ratio (%) |
| 15-1 | LiFePO₄ | Graphite | Formula | 1 | 75.3 |
| | | | (4-1) | | |
| 15-2 | | | Formula | 1 | 78.1 |
| | | | (4-2) | | |
| 15-3 | | | Formula | 1 | 75.2 |
| | | | (4-3) | | |
| 15-4 | | | Formula | 1 | 76.7 |
| | | | (4-4) | | |
| 15-5 | | | Formula | 1 | 75.2 |
| | | | (4-5) | | |
| 15-6 | LiFePO₄ | Silicon | Formula | 1 | 64.2 |
| | | | (4-1) | | |
| 15-7 | | | Formula | 1 | 70 |
| | | | (4-2) | | |
| 15-8 | | | Formula | 1 | 62.3 |
| | | | (4-3) | | |
| 15-9 | | | Formula | 1 | 68 |
| | | | (4-4) | | |
| 15-10 | | | Formula | 1 | 64.6 |
| | | | (4-5) | | |
| 15-11 | LiFePO₄ | Silicon iron | Formula | 1 | 57.7 |
| | | alloy | (4-1) | | |
| 15-12 | | | Formula | 1 | 65.5 |
| | | | (4-2) | | |
| 15-13 | | | Formula | 1 | 59.2 |
| | | | (4-3) | | |
| 15-14 | | | Formula | 1 | 59.3 |
| | | | (4-4) | | |
| 15-15 | | | Formula | 1 | 58.1 |
| | | | (4-5) | | |
| 15-16 | LiFePO₄ | Graphite | — | — | 76.4 |
| 15-17 | LiFePO₄ | Silicon | — | — | 65.6 |
| 15-18 | LiFePO₄ | Silicon iron | — | — | 61.6 |
| | | alloy | | | |

TABLE 16
Electrolyte = Electrolytic Layer, Upper Limit Voltage =
4.2 V, Lower Limit Voltage = 3 V

| | Cathode | Anode | | | Capacity |
|---|---|---|---|---|---|
| Experi- | Active | Active | Silyl Compound | | Main- |
| mental | Substance | Substance | | Content | taining |
| Example | Type | Type | Type | (wt %) | Ratio (%) |
| 16-1 | LiMn₂O₄ | Graphite | Formula | 1 | 71.5 |
| | | | (4-1) | | |
| 16-2 | | | Formula | 1 | 72 |
| | | | (4-2) | | |
| 16-3 | | | Formula | 1 | 75.2 |
| | | | (4-3) | | |
| 16-4 | | | Formula | 1 | 72.8 |
| | | | (4-4) | | |
| 16-5 | | | Formula | 1 | 71.4 |
| | | | (4-5) | | |
| 16-6 | LiMn₂O₄ | Silicon | Formula | 1 | 58.9 |
| | | | (4-1) | | |
| 16-7 | | | Formula | 1 | 58.6 |
| | | | (4-2) | | |
| 16-8 | | | Formula | 1 | 64.4 |
| | | | (4-3) | | |
| 16-9 | | | Formula | 1 | 64.8 |
| | | | (4-4) | | |
| 16-10 | | | Formula | 1 | 59.3 |
| | | | (4-5) | | |
| 16-11 | LiMn₂O₄ | Silicon iron | Formula | 1 | 52.1 |
| | | alloy | (4-1) | | |
| 16-12 | | | Formula | 1 | 55.6 |
| | | | (4-2) | | |
| 16-13 | | | Formula | 1 | 57.5 |
| | | | (4-3) | | |
| 16-14 | | | Formula | 1 | 60.7 |
| | | | (4-4) | | |
| 16-15 | | | Formula | 1 | 50.8 |
| | | | (4-5) | | |
| 16-16 | LiMn₂O₄ | Graphite | — | — | 72.4 |
| 16-17 | LiMn₂O₄ | Silicon | — | — | 62.3 |
| 16-18 | LiMn₂O₄ | Silicon iron | — | — | 53.1 |
| | | alloy | | | |

In a case of charging and discharging the secondary battery, which used another material as the cathode active substance, under the high charging voltage condition (Table 13 to Table 16), different results from in the case of charging and discharging the secondary battery, which used a specific lithium-containing compound as the cathode active substance, under the high charging voltage condition (Table 1 to Table 12) were obtained. In detail, in a case of using another material as the cathode active substance, when the secondary battery was charged and discharged under the high charging voltage condition, the capacity maintaining ratio increased only a little according to the presence or absence of the silyl compound in the electrolytic solution, and the capacity maintaining ratio decreased in some cases.

### Experimental Examples 17-1 to 17-18 and 18-1 to 18-18

As shown in Table 17 and Table 18, a secondary battery was manufactured and the battery characteristics were examined according to the same steps apart from charging and discharging the secondary battery, which used a specific lithium-containing compound (LiCoO₂) as the cathode active substance, under the low charging voltage condition.

TABLE 17
Electrolyte = Electrolytic Solution, Upper Limit Voltage =
4.2 V, Lower Limit Voltage = 3 V

| | Cathode | Anode | | | Capacity |
|---|---|---|---|---|---|
| Experi- | Active | Active | Silyl Compound | | Main- |
| mental | Substance | Substance | | Content | taining |
| Example | Type | Type | Type | (wt %) | Ratio (%) |
| 17-1 | LiCoO₂ | Graphite | Formula | 1 | 78.4 |
| | | | (4-1) | | |
| 17-2 | | | Formula | 1 | 78.4 |
| | | | (4-2) | | |
| 17-3 | | | Formula | 1 | 79.7 |
| | | | (4-3) | | |
| 17-4 | | | Formula | 1 | 79.5 |
| | | | (4-4) | | |
| 17-5 | | | Formula | 1 | 79 |
| | | | (4-5) | | |
| 17-6 | LiCoO₂ | Silicon | Formula | 1 | 66.9 |
| | | | (4-1) | | |
| 17-7 | | | Formula | 1 | 67.1 |
| | | | (4-2) | | |
| 17-8 | | | Formula | 1 | 68.8 |
| | | | (4-3) | | |
| 17-9 | | | Formula | 1 | 69 |
| | | | (4-4) | | |
| 17-10 | | | Formula | 1 | 68.4 |
| | | | (4-5) | | |
| 17-11 | LiCoO₂ | Silicon iron | Formula | 1 | 61.7 |
| | | alloy | (4-1) | | |
| 17-12 | | | Formula | 1 | 61.9 |
| | | | (4-2) | | |
| 17-13 | | | Formula | 1 | 61.3 |
| | | | (4-3) | | |
| 17-14 | | | Formula | 1 | 60.5 |
| | | | (4-4) | | |
| 17-15 | | | Formula | 1 | 61.4 |
| | | | (4-5) | | |
| 17-16 | LiCoO₂ | Graphite | — | — | 79.7 |
| 17-17 | LiCoO₂ | Silicon | — | — | 68.7 |
| 17-18 | LiCoO₂ | Silicon iron | — | — | 61.4 |
| | | alloy | | | |

TABLE 18
Electrolyte = Electrolytic Layer, Upper Limit Voltage =
4.2 V, Lower Limit Voltage = 3 V

| | Cathode | Anode | | | Capacity |
|---|---|---|---|---|---|
| Experi- | Active | Active | Silyl Compound | | Main- |
| mental | Substance | Substance | | Content | taining |
| Example | Type | Type | Type | (wt %) | Ratio (%) |
| 18-1 | LiCoO₂ | Graphite | Formula | 1 | 76.1 |
| | | | (4-1) | | |
| 18-2 | | | Formula | 1 | 77.4 |
| | | | (4-2) | | |
| 18-3 | | | Formula | 1 | 74.8 |
| | | | (4-3) | | |
| 18-4 | | | Formula | 1 | 76.3 |
| | | | (4-4) | | |
| 18-5 | | | Formula | 1 | 75.4 |
| | | | (4-5) | | |
| 18-6 | LiCoO₂ | Silicon | Formula | 1 | 67.9 |
| | | | (4-1) | | |
| 18-7 | | | Formula | 1 | 67.6 |
| | | | (4-2) | | |
| 18-8 | | | Formula | 1 | 68.6 |
| | | | (4-3) | | |
| 18-9 | | | Formula | 1 | 66.9 |
| | | | (4-4) | | |
| 18-10 | | | Formula | 1 | 67.7 |
| | | | (4-5) | | |
| 18-11 | LiCoO₂ | Silicon iron | Formula | 1 | 60.8 |
| | | alloy | (4-1) | | |
| 18-12 | | | Formula | 1 | 60 |
| | | | (4-2) | | |
| 18-13 | | | Formula | 1 | 60.7 |
| | | | (4-3) | | |
| 18-14 | | | Formula | 1 | 61.6 |
| | | | (4-4) | | |
| 18-15 | | | Formula | 1 | 59.1 |
| | | | (4-5) | | |
| 18-16 | LiCoO₂ | Graphite | — | — | 76.1 |
| 18-17 | LiCoO₂ | Silicon | — | — | 67.4 |
| 18-18 | LiCoO₂ | Silicon iron | — | — | 60.7 |
| | | alloy | | | |

In a case of charging and discharging the secondary battery, which used a special lithium-containing compound as the cathode active substance, under the low charging voltage condition (Table 17 and Table 18), different results from in the case of charging and discharging the secondary battery under the high charging voltage condition (Table 1 to Table 12) were obtained. In detail, in a case of charging and discharging the secondary battery under the low charging voltage condition, the capacity maintaining ratio increased only a little according to the presence or absence of the silyl compound in the electrolytic solution, and the capacity maintaining ratio decreased in most cases.

From the results in Table 1 to Table 18, when the cathode included a specific lithium-containing compound and the electrolytic solution included a silyl compound, the cycle characteristics improved. Thus, excellent battery characteristics were obtained.

Above, description was given of the present technology using the embodiments and the Examples; however, the present technology is not limited to the forms described in the embodiments and the Examples and various types of modifications are possible.

For example, description was given using cases where the battery structure was a cylindrical type and a laminate film type as examples and using a case where the battery element had a winding structure as an example; however, the present technology is not limited thereto. The secondary battery of the present technology is able to be applied in the same manner in a case of having another battery structure such as a square type, a coin type, a button type, and the like, or also in a case where the battery element has another structure such as a laminate structure.

In addition, for example, the electrode reactant may be another group 1 element such as sodium (Na) and potassium (K), may be a group 2 element such as magnesium and calcium, or may be another light metal such as aluminum. Since it may be expected that the effect of the present technology will be obtained regardless of the type of the electrode reactant, it is possible to obtain the same effect even when the type of the electrode reactant is changed.

Here, the present technology is also able to adopt the following configurations.

(1) A secondary battery including a cathode, an anode, and a non-aqueous electrolytic solution, in which the cathode includes an electrode compound which absorbs and releases an electrode reactant at a potential of 4.5 V or higher (potential versus lithium), and the non-aqueous electrolytic solution includes a silyl compound where one or two or more silicon-oxygen-containing groups (SiR₃—O—: the three R's are respectively any one of a monovalent hydrocarbon group and a halogenated group thereof) are bonded with an atom other than silicon.

(2) The secondary battery according to (1) described above, in which the electrode compound includes at least one type from among compounds which are represented by formula (1) to formula (3) respectively.

Li₁₊ₐ(Mn_{b}Co_{c}Ni_{1-b-c})₁₋ₐM1_{d}O₂₋ₑ (1)

(M1 is at least one type from among elements which belong to group 2 to group 15 of the long form of the periodic table (excluding manganese (Mn), cobalt (Co), and nickel (Ni)). a to e satisfy 0<a<0.25, 0.3≦b<0.7, 0≦c<1−b, 0≦d≦1, and 0≦e≦1.)

Li_{f}Ni_{1-g-h}Mn_{g}M2ₕO₂₋ᵢXⱼ (2)

(M2 is at least one type from among elements which belong to group 2 to group 15 of the long form of the periodic table (excluding nickel and manganese). X is at least one type from among elements which belong to group 16 and group 17 of the long form of the periodic table (excluding oxygen (O)). f to j satisfy 0≦f≦1.5, 0≦g≦1, 0≦h≦1, −0.1≦i≦0.2, and 0≦j≦0.2)

LiM3ₖMn₂₋ₖO₄ (3)

(M3 is at least one type from among elements which belong to group 2 to group 15 of the long form of the periodic table (excluding manganese). k satisfies 0<k≦1.)

(3) The secondary battery according to (2) described above, in which each of M1 and M3 includes at least one type from among nickel, cobalt, magnesium (Mg), aluminum (Al), boron (B), titanium (Ti), vanadium (V), chromium (Cr), iron (Fe), copper (Cu), zinc (Zn), zirconium (Zr), molybdenum (Mo), tin (Sn), calcium (Ca), strontium (Sr), tungsten (W), silicon (Si), and barium (Ba), M2 includes at least one type from among cobalt, magnesium, aluminum, boron, titanium, vanadium, chromium, iron, copper, zinc, zirconium, molybdenum, tin, calcium, strontium, tungsten, silicon, and barium, and X includes at least one type from among fluorine (F), chlorine (Cl), bromine (Br), and iodine (I).

(4) The secondary battery according to (2) or (3) described above, in which f satisfies 0<f≦1.5, or h satisfies 0≦h<1.

(5) The secondary battery according to any of (1) to (4) described above, in which the atom other than silicon is any atom from among aluminum, boron, phosphorus (P), sulfur (S), carbon (C), and hydrogen (H), the monovalent hydrocarbon group is any one of groups where an alkyl group, an alkenyl group, an alkynyl group, a cycloalkyl group, an aryl group, and a group in which two types or more thereof are bonded so as to be monovalent, and the halogenated group includes at least one type from among a fluorine group (—F), a chlorine group (—Cl), a bromine group (—Br), and an iodine group (—I).

(6) The secondary battery according to any of (1) to (5) described above, in which the silyl compound includes a compound which is represented by formula (4).

(SiR1₃-O—)m-Y (4)

(The three R1's are respectively any one of a monovalent hydrocarbon group and a halogenated group thereof. Y is a group which includes any atom among aluminum, boron, phosphorus, sulfur, carbon, and hydrogen as a constituent atom. However, the ether bond (—O—) in the silicon-oxygen-containing groups is bonded with any atom from among aluminum, boron, phosphorus, sulfur, carbon, and hydrogen in Y. m is an integer of 1 or more.)

(7) The secondary battery according to (6) described above, in which Y is any group among groups which are represented by formula (4-21) to formula (4-31) respectively.

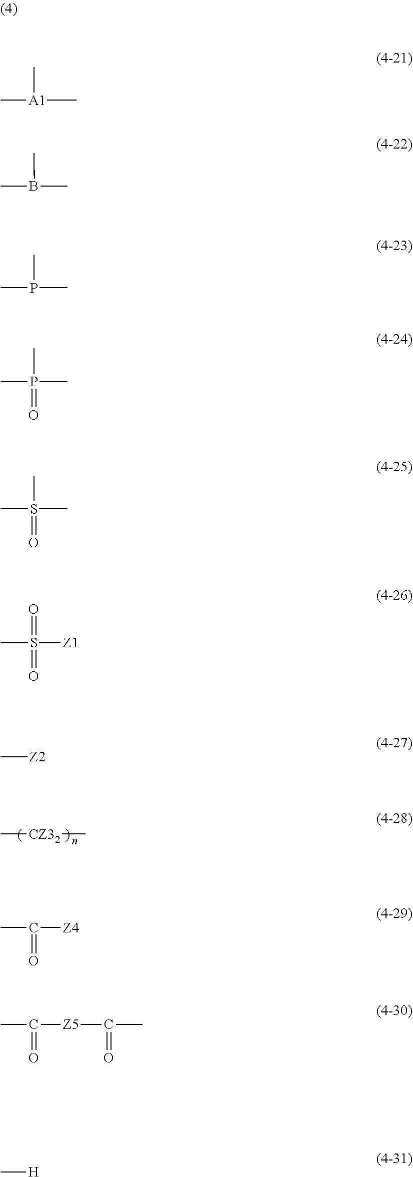

(Z1 is a halogen group. Z2 and Z4 are any one of a monovalent hydrocarbon group and a halogenated group thereof. Z3 is any one of a hydrogen group and a halogenated group. Z5 is any one of a divalent hydrocarbon group and a halogenated group. n is an integer of 1 or more.)

(8) The secondary battery according to (7) described above, in which the halogen group is any group from among a fluorine group, a chlorine group, a bromine group, and an iodine group, the monovalent hydrocarbon group is any group from among groups where an alkyl group, an alkenyl group, an alkynyl group, a cycloalkyl group, an aryl group, and a group in which two types or more thereof are bonded so as to be monovalent, the divalent hydrocarbon group is any one of groups where an alkylene group, an alkenylene group, an alkynylene group, a cycloalkylene group, an arylene group, and a group in which two types or more thereof are bonded so as to be divalent, and the halogenated group includes at least one type from among a fluorine group, a chlorine group, a bromine group, and an iodine group.

(9) the secondary battery according to any of (1) to (8) described above, in which the silyl compound includes at least one type from among compounds which are represented by formula (4-1) to formula (4-17) respectively.

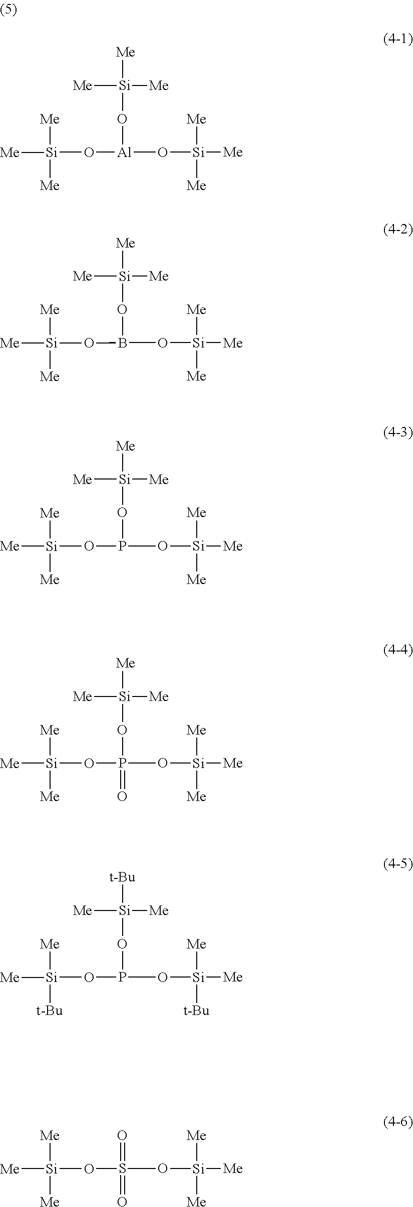

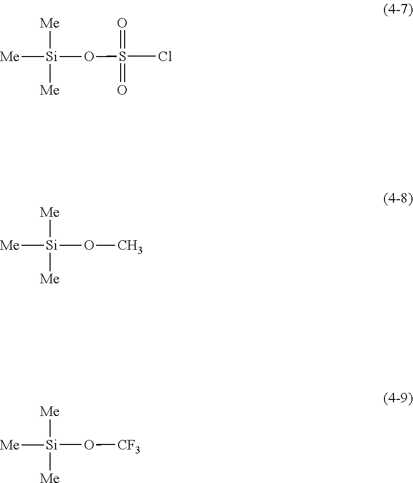

(-Me represents a methyl group, and -t-Bu represents a t-butyl group.)

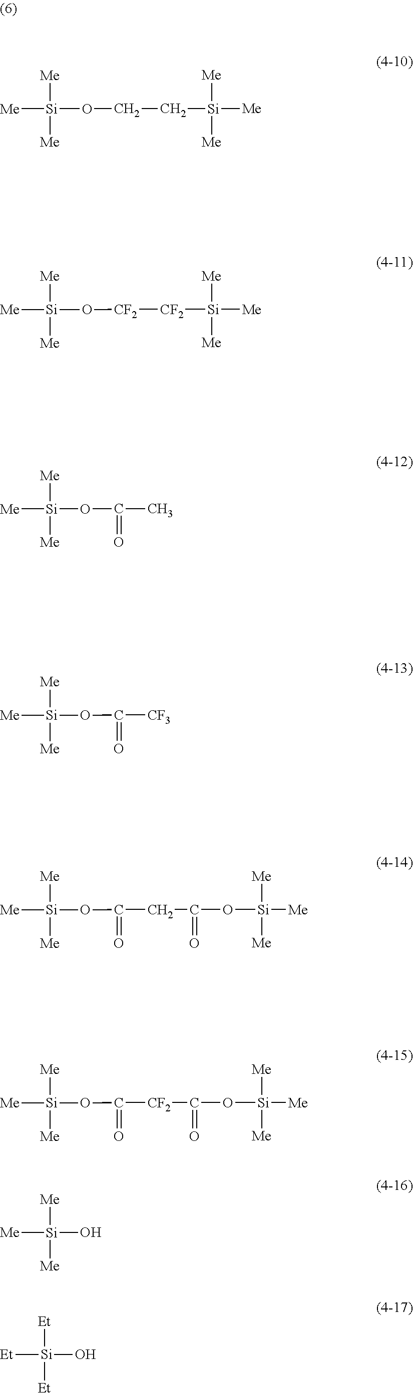

(-Me represents a methyl group and -Et represents an ethyl group.)

(10) The secondary battery according to any of (1) to (9) described above, in which content of the silyl compound in the non-aqueous electrolytic solution is 0.01 wt % to 3 wt %.

(11) The secondary battery according to any of (1) to (10) described above, which is a lithium ion secondary battery.

(12) A battery pack including the secondary battery according to any of (1) to (11) described above, a control section which controls the operation of the secondary battery, and a switching section which switches the operation of the secondary battery according to instructions of the control section.

(13) An electric vehicle including the secondary battery according to any of (1) to (11) described above, a conversion section which converts power which is supplied from the secondary battery into driving force, a driving section which drives according to the driving force, and a control section which controls the operation of the secondary battery.

(14) A power storage system including the secondary battery according to any of (1) to (11) described above, one or two or more electrical devices to which power is supplied from the secondary battery, and a control section which controls a power supply from the secondary battery with respect to the electrical devices.

(15) A power tool including the secondary battery according to any of (1) to (11) described above, and a movable section to which power is supplied from the secondary battery.

(16) An electronic device including the secondary battery according to any of (1) to (11) described above as a power supply source.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A secondary battery comprising:
a cathode;
an anode; and
a non-aqueous electrolytic solution,
wherein the cathode includes an electrode compound which absorbs and releases an electrode reactant at a potential of 4.5 V or higher (potential versus lithium), and
the non-aqueous electrolytic solution includes a silyl compound where one or two or more silicon-oxygen-containing groups (SiR₃—O—: the three R's are respectively any one of a monovalent hydrocarbon group and a halogenated group thereof) are bonded with an atom other than silicon.

2. The secondary battery according to claim 1,
wherein the electrode compound includes at least one type from among compounds which are represented by formula (1) to formula (3) respectively,
Li₁₊ₐ(Mn_{b}Co_{c}Ni_{1-b-c})₁₋ₐM1_{d}O₂₋ₑ (1)
(where M1 is at least one type from among elements which belong to group 2 to group 15 of the long form of the periodic table (excluding manganese (Mn), cobalt (Co), and nickel (Ni)), and a to e satisfy 0<a<0.25, 0.3≦b<0.7, 0≦c<1−b, 0≦d≦1, and 0≦e≦1)
Li_{f}Ni_{1-g-h}Mn_{g}M2ₕO₂₋ᵢXⱼ (2)
(where M2 is at least one type from among elements which belong to group 2 to group 15 of the long form of the periodic table (excluding nickel and manganese), X is at least one type from among elements which belong to group 16 and group 17 of the long form of the periodic table (excluding oxygen (O)), and f to j satisfy 0≦f≦1.5, 0≦g≦1, 0≦h≦1, −0.1≦i≦0.2, and 0≦j≦0.2)
LiM3ₖMn₂₋ₖO₄ (3)
(where M3 is at least one type from among elements which belong to group 2 to group 15 of the long form of the periodic table (excluding manganese), and k satisfies 0<k≦1.)

3. The secondary battery according to claim 2,
wherein each of M1 and M3 includes at least one type from among nickel, cobalt, magnesium (Mg), aluminum (Al), boron (B), titanium (Ti), vanadium (V), chromium (Cr), iron (Fe), copper (Cu), zinc (Zn), zirconium (Zr), molybdenum (Mo), tin (Sn), calcium (Ca), strontium (Sr), tungsten (W), silicon (Si), and barium (Ba),
M2 includes at least one type from among cobalt, magnesium, aluminum, boron, titanium, vanadium, chromium, iron, copper, zinc, zirconium, molybdenum, tin, calcium, strontium, tungsten, silicon, and barium, and
X includes at least one type from among fluorine (F), chlorine (Cl), bromine (Br), and iodine (I).

4. The secondary battery according to claim 2,
wherein f satisfies 0<f≦1.5, or
h satisfies 0≦h<1.

5. The secondary battery according to claim 1,
wherein the atom other than silicon is any atom from among aluminum, boron, phosphorus (P), sulfur (S), carbon (C), and hydrogen (H),
the monovalent hydrocarbon group is any group from among groups where an alkyl group, an alkenyl group, an alkynyl group, a cycloalkyl group, an aryl group, and a group in which two types or more thereof are bonded so as to be monovalent, and
the halogenated group includes at least one type from among a fluorine group (—F), a chlorine group (—Cl), a bromine group (—Br), and an iodine group (—I).

6. The secondary battery according to claim 1,
wherein the silyl compound includes a compound which is represented by formula (4),
(SiR1₃-O—)ₘ—Y (4)
(where the three R1's are respectively any one of a monovalent hydrocarbon group and a halogenated group thereof, Y is a group which includes any atom from among aluminum, boron, phosphorus, sulfur, carbon, and hydrogen as a constituent atom, However, the ether bond (—O—) in the silicon-oxygen-containing groups is bonded with any atom from among aluminum, boron, phosphorus, sulfur, carbon, and hydrogen in Y, and m is an integer of 1 or more.)

7. The secondary battery according to claim 6,
wherein Y is any group from among groups which are represented by formula (4-21) to formula (4-31) respectively, 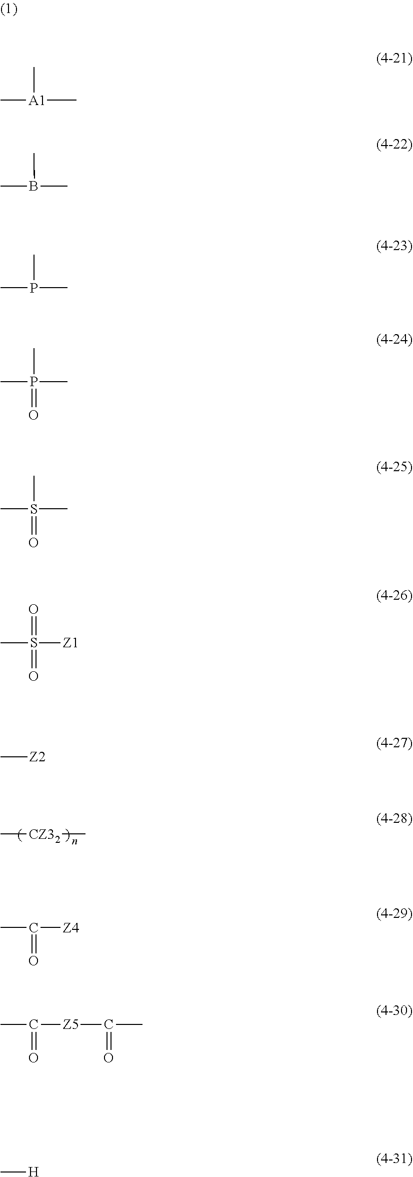
(where Z1 is a halogen group, Z2 and Z4 are any one of a monovalent hydrocarbon group and a halogenated group thereof, Z3 is any group from among a hydrogen group and a halogenated group, Z5 is any group from among a divalent hydrocarbon group and a halogenated group thereof, and n is an integer of 1 or more.)

8. The secondary battery according to claim 7,
wherein the halogen group is any group from among a fluorine group, a chlorine group, a bromine group, and an iodine group,
the monovalent hydrocarbon group is any group from among groups where an alkyl group, an alkenyl group, an alkynyl group, a cycloalkyl group, an aryl group, and a group in which two types or more thereof are bonded so as to be monovalent,
the divalent hydrocarbon group is any one of groups where an alkylene group, an alkenylene group, an alkynylene group, a cycloalkylene group, an arylene group, and a group in which two types or more thereof are bonded so as to be divalent, and
the halogenated group includes at least one type from among a fluorine group, a chlorine group, a bromine group, and an iodine group.

9. The secondary battery according to claim 1,
wherein the silyl compound includes at least one type from among compounds which are represented by formula (4-1) to formula (4-17) respectively, 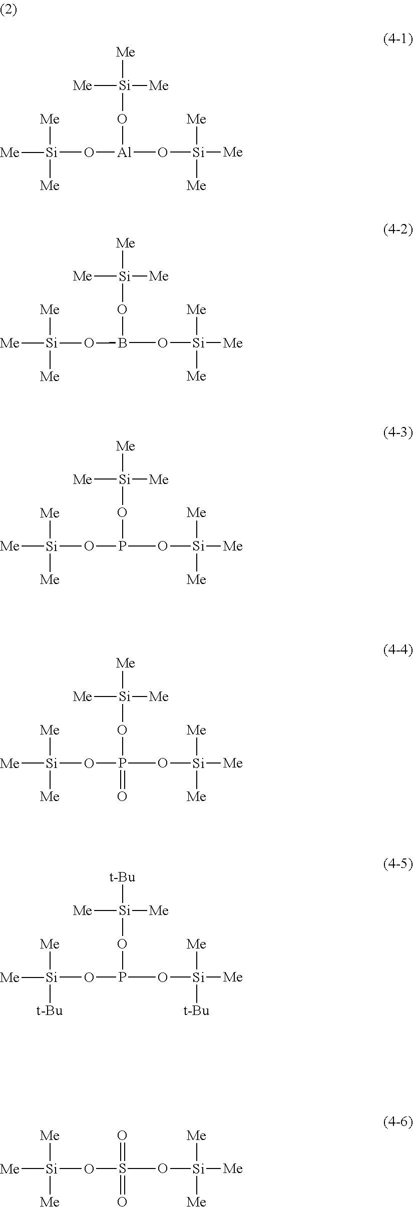 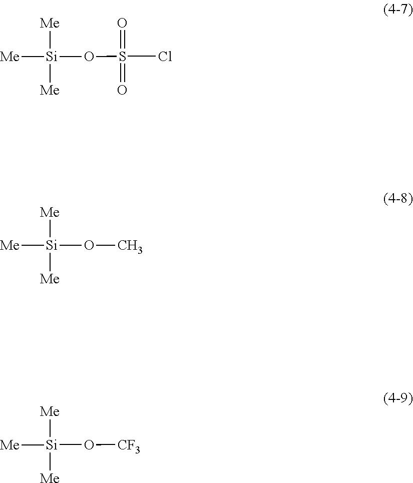
(where -Me represents a methyl group, and -t-Bu represents a t-butyl group) 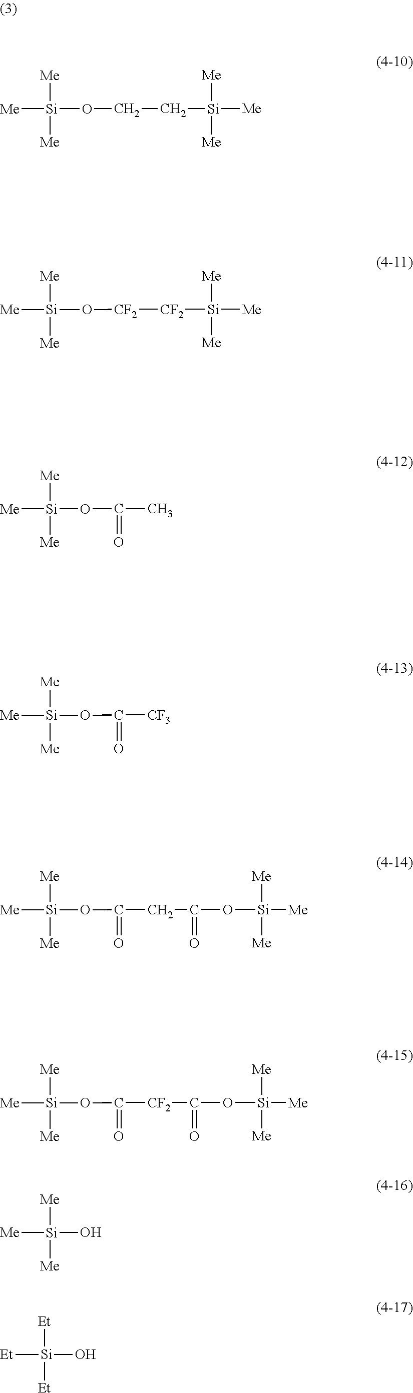
(where -Me represents a methyl group and -Et represents an ethyl group.)

10. The secondary battery according to claim 1,
wherein content of the silyl compound in the non-aqueous electrolytic solution is 0.01 wt % to 3 wt %.

11. The secondary battery according to claim 1, which is a lithium ion secondary battery.

12. A battery pack comprising:
a secondary battery;
a control section which controls an operation of the secondary battery; and
a switching section which switches the operation of the secondary battery according to instructions of the control section,
wherein the secondary battery is provided with a cathode, an anode, and a non-aqueous electrolytic solution,
the cathode includes an electrode compound which absorbs and releases an electrode reactant at a potential of 4.5 V or higher (potential versus lithium), and
the non-aqueous electrolytic solution includes a silyl compound where one or two or more silicon-oxygen-containing groups (SiR₃—O—: the three R's are respectively any one of a monovalent hydrocarbon group and a halogenated group thereof) are bonded with an atom other than silicon.

13. An electric vehicle comprising:
a secondary battery;
a conversion section which converts power which is supplied from the secondary battery into driving force;
a driving section which drives according to the driving force; and
a control section which controls an operation of the secondary battery,
wherein the secondary battery is provided with a cathode, an anode, and a non-aqueous electrolytic solution,
the cathode includes an electrode compound which absorbs and releases an electrode reactant at a potential of 4.5 V or higher (potential versus lithium), and
the non-aqueous electrolytic solution includes a silyl compound where one or two or more silicon-oxygen-containing groups (SiR₃—O—: the three R's are respectively any one of a monovalent hydrocarbon group and a halogenated group thereof) are bonded with an atom other than silicon.

14. A power storage system comprising:
a secondary battery;
one or two or more electrical devices to which power is supplied from the secondary battery; and
a control section which controls a power supply from the secondary battery with respect to the electrical devices,
wherein the secondary battery is provided with a cathode, an anode, and a non-aqueous electrolytic solution,
the cathode includes an electrode compound which absorbs and releases an electrode reactant at a potential of 4.5 V or higher (potential versus lithium), and
the non-aqueous electrolytic solution includes a silyl compound where one or two or more silicon-oxygen-containing groups (SiR₃—O—: the three R's are respectively any one of a monovalent hydrocarbon group and a halogenated group thereof) are bonded with an atom other than silicon.

15. A power tool comprising:
a secondary battery; and
a movable section to which power is supplied from the secondary battery,
wherein the secondary battery is provided with a cathode, an anode, and a non-aqueous electrolytic solution,
the cathode includes an electrode compound which absorbs and releases an electrode reactant at a potential of 4.5 V or higher (potential versus lithium), and
the non-aqueous electrolytic solution includes a silyl compound where one or two or more silicon-oxygen-containing groups (SiR₃—O—: the three R's are respectively any one of a monovalent hydrocarbon group and a halogenated group thereof) are bonded with an atom other than silicon.

16. An electronic device comprising:
a secondary battery as a power supply source,
wherein the secondary battery is provided with a cathode, an anode, and a non-aqueous electrolytic solution,
the cathode includes an electrode compound which absorbs and releases an electrode reactant at a potential of 4.5 V or higher (potential versus lithium), and
the non-aqueous electrolytic solution includes a silyl compound where one or two or more silicon-oxygen-containing groups (SiR₃—O—: the three R's are respectively any one of a monovalent hydrocarbon group and a halogenated group thereof) are bonded with an atom other than silicon.
